(19) United States
(12) Patent Application Publication
(10) Pub. No.: US 2019/0102946 A1
(43) Pub. Date: Apr. 4, 2019

(54) SYSTEMS, METHODS AND APPARATUSES FOR DEPLOYMENT AND TARGETING OF CONTEXT-AWARE VIRTUAL OBJECTS AND BEHAVIOR MODELING OF VIRTUAL OBJECTS BASED ON PHYSICAL PRINCIPLES

(71) Applicant: Magical Technologies, LLC, Redmond, WA (US)

(72) Inventors: Nova Spivack, Sherman Oaks, CA (US); Yenyun Fu, Sherman Oaks, CA (US); Matthew Hoerl, Sherman Oaks, CA (US); Armando Pena, Sherman Oaks, CA (US)

(21) Appl. No.: 16/056,507

(22) Filed: Aug. 6, 2018

Related U.S. Application Data
(60) Provisional application No. 62/581,989, filed on Nov. 6, 2017.
(60) Provisional application No. 62/575,458, filed on Oct. 22, 2017.
(60) Provisional application No. 62/557,775, filed on Sep. 13, 2017.
(60) Provisional application No. 62/541,169, filed on Aug. 4, 2017.

(51) Int. Cl. G06T 19/00; G06K 9/00; G06T 15/00; G06F 3/01

(52) U.S. Cl. CPC G06T 19/006; G06T 19/003; G06K 9/00671; G06T 2215/16; G06F 3/011; G06F 3/016; G06F 3/017; G06T 15/005

(57) ABSTRACT

Systems, Methods and Apparatuses for Deployment and Targeting of Context-Aware Virtual Objects and Behavior Modeling of Virtual Objects Based on Physical Principles are disclosed. In one aspect, embodiments of the present disclosure include a method, which may be implemented on a system, to detect an indication that a content segment being consumed in the target environment has virtual content associated with it. The method can further include presenting the virtual content that is contextually relevant for consumption in target environment. In addition, contextual information for the target environment can be captured.

### CLAIM OF PRIORITY

This application claims the benefit of:
U.S. Provisional Application No. 62/541,169, filed Aug. 4, 2017 and entitled “Systems, Methods and Apparatuses of Interacting with Virtual Objects Associated With Content or Physical Objects,” (8003.US00), the contents of which are incorporated by reference in their entirety;
U.S. Provisional Application No. 62/557,775, filed Sep. 13, 2017 and entitled “Systems and Methods of Augmented Reality Enabled Applications Including Social Activities or Web Activities and Apparatuses of Tools Therefor,” (8004.US00), the contents of which are incorporated by reference in their entirety;
U.S. Provisional Application No. 62/575,458, filed Oct. 22, 2017 and entitled “Systems, Methods and Apparatuses of Single directional or Multi-directional Lens/Mirrors or Portals between the Physical World and a Digital World of Augmented Reality (AR) or Virtual Reality (VR) Environment/Objects; Systems and Methods of On-demand Curation of Crowdsourced (near) Real time Imaging/Video Feeds with Associated VR/AR Objects; Systems and Methods of Registry, Directory and/or Index for Augmented Reality and/or Virtual Reality Objects,” (8005.US00), the contents of which are incorporated by reference in their entirety; and
U.S. Provisional Application No. 62/581,989, filed Nov. 6, 2017 and entitled “Systems, Methods and Apparatuses of: Determining or Inferring Device Location using Digital Markers; Virtual Object Behavior Implementation and Simulation Based on Physical Laws or Physical/Electrical/Material/Mechanical/Optical/Chemical Properties; User or User Customizable 2D or 3D Virtual Objects; Analytics of Virtual Object Impressions in Augmented Reality and Applications; Video objects in VR and/or AR and Interactive Multidimensional Virtual Objects with Media or Other Interactive Content,” (8006.US00), the contents of which are incorporated by reference in their entirety.

### RELATED APPLICATIONS

This application is related to PCT Application no. PCT/US2018/45450, filed Aug. 6, 2018 and entitled “SYSTEMS, METHODS AND APPARATUSES FOR DEPLOYMENT AND TARGETING OF CONTEXT-AWARE VIRTUAL OBJECTS AND BEHAVIOR MODELING OF VIRTUAL OBJECTS BASED ON PHYSICAL PRINCIPLES” (8003.WO01), the contents of which are incorporated by reference in their entirety.

### TECHNICAL FIELD

The disclosed technology relates generally to augmented reality environments and context aware virtual objects, behavior modeling of virtual objects and/or augmented/virtual reality workspaces.

### BACKGROUND

The advent of the World Wide Web and its proliferation in the 90's transformed the way humans conduct business, live lives, consume/communicate information and interact with or relate to others. A new wave of technology is on the cusp of the horizon to revolutionize our already digitally immersed lives.

### BRIEF DESCRIPTION OF THE DRAWINGS

FIG. 1 illustrates an example block diagram of a host server able to deploy and target context-aware virtual objects and/or to model behavior of virtual objects based on physical principles, in accordance with embodiments of the present disclosure.

FIG. 2A depicts example diagrams of virtual objects with behavior characteristics governed by physical laws of the real world, in accordance with embodiments of the present disclosure.

FIG. 2B depicts example diagrams of context-aware virtual objects that are deployed in a target environment, in accordance with embodiments of the present disclosure.

FIG. 3A depicts an example functional block diagram of a host server that deploys and/or targets context-aware virtual objects and/or models behavior of virtual objects based on physical principles, in accordance with embodiments of the present disclosure.

FIG. 3B depicts an example block diagram illustrating the components of the host server that deploys and/or targets context-aware virtual objects and/or models behavior of virtual objects based on physical principles, in accordance with embodiments of the present disclosure.

FIG. 4A depicts an example functional block diagram of a client device such as a mobile device that captures contextual information for a target environment and/or presents virtual objects with characteristics modeled based on physical laws of the real world, in accordance with embodiments of the present disclosure.

FIG. 4B depicts an example block diagram of the client device, which can be a mobile device that captures contextual information for a target environment and/or presents virtual objects with characteristics modeled based on physical laws of the real world, in accordance with embodiments of the present disclosure.

FIG. 5A-5B graphically depicts views of examples of virtual objects that are context aware to a target environment in which they are deployed and/or virtual objects which are modeled based on physical laws or principles, in accordance with embodiments of the present disclosure.

FIG. 6 graphically depicts an example of a content segment being consumed, that is associated with a virtual object, in accordance with embodiments of the present disclosure.

FIG. 7 graphically depicts a view of an example of a virtual reality workspace and virtual objects with multiple animation states, in accordance with embodiments of the present disclosure.

FIG. 8 graphically depicts a view of examples of virtual object, in accordance with embodiments of the present disclosure.

FIG. 9A-9B depicts a flow chart depict flow charts illustrating example processes to generate a behavioral profile for the object modelled based on a physical law of the real world and/or to update a depiction of the object in an augmented reality environment, based on the physical law or principle, in accordance with embodiments of the present disclosure.

FIG. 10A depicts a flow chart illustrating an example process to present virtual content for consumption in a target environment, in accordance with embodiments of the present disclosure.

FIG. 10B depicts a flow chart illustrating an example process to provide an augmented reality workspace in a physical space, in accordance with embodiments of the present disclosure.

FIG. 11 is a block diagram illustrating an example of a software architecture that may be installed on a machine, in accordance with embodiments of the present disclosure.

FIG. 12 is a block diagram illustrating components of a machine, according to some example embodiments, able to read a set of instructions from a machine-readable medium (e.g., a machine-readable storage medium) and perform any one or more of the methodologies discussed herein.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

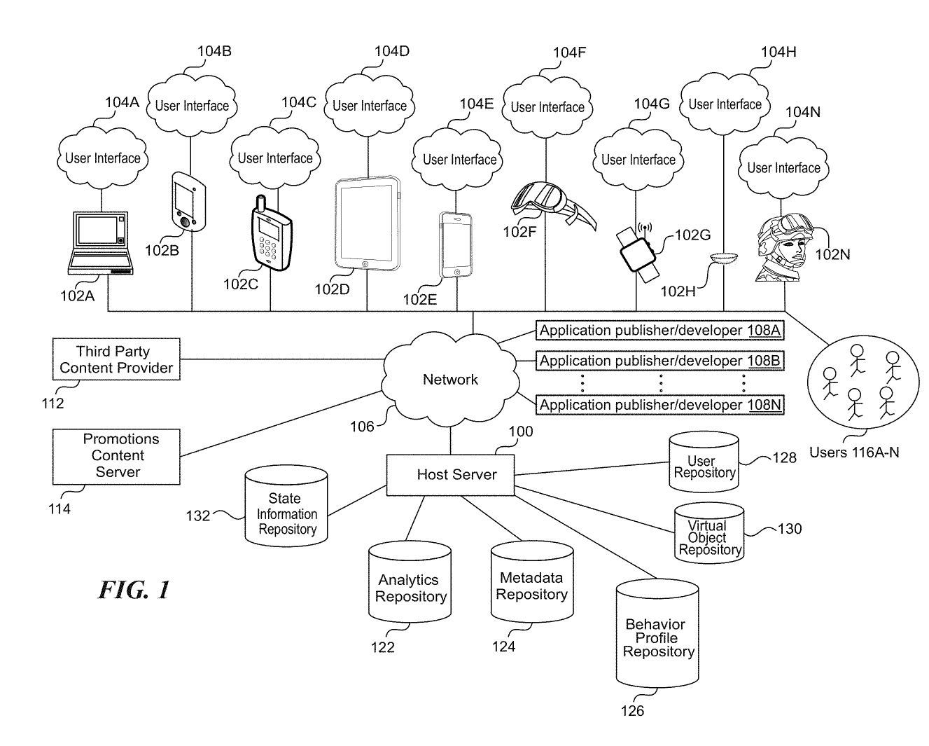

Embodiments of the present disclosure include systems, methods and apparatuses of platforms (e.g., as hosted by the host server 100 as depicted in the example of FIG. 1) for deployment and targeting of context-aware virtual objects and/or behavior modeling of virtual objects based on physical laws or principle. Further embodiments relate to how interactive virtual objects that correspond to content or physical objects in the physical world are detected and/or generated, and how users can then interact with those virtual objects, and/or the behavioral characteristics of the virtual objects, and how they can be modeled. Embodiments of the present disclosure further include processes that augmented reality data (such as a label or name or other data) with media content, media content segments (digital, analog, or physical) or physical objects. Yet further embodiments of the present disclosure include a platform (e.g., as hosted by the host server 100 as depicted in the example of FIG. 1) to provide an augmented reality (AR) workspace in a physical space, where a virtual object can be rendered as a user interface element of the AR workspace.

Embodiments of the present disclosure further include systems, methods and apparatuses of platforms (e.g., as hosted by the host server 100 as depicted in the example of FIG. 1) for managing and facilitating transactions or other activities associated with virtual real-estate (e.g., or digital real-estate). In general, the virtual or digital real-estate is associated with physical locations in the real world. The platform facilitates monetization and trading of a portion or portions of virtual spaces or virtual layers (e.g., virtual real-estate) of an augmented reality (AR) environment (e.g., alternate reality environment, mixed reality (MR) environment) or virtual reality VR environment.

In an augmented reality environment (AR environment), scenes or images of the physical world is depicted with a virtual world that appears to a human user, as being superimposed or overlaid of the physical world. Augmented reality enabled technology and devices can therefore facilitate and enable various types of activities with respect to and within virtual locations in the virtual world. Due to the inter connectivity and relationships between the physical world and the virtual world in the augmented reality environment, activities in the virtual world can drive traffic to the corresponding locations in the physical world. Similarly, content or virtual objects (VOBs) associated with busier physical locations or placed at certain locations (e.g., eye level versus other levels) will likely have a larger potential audience.

By virtual of the inter-relationship and connections between virtual spaces and real world locations enabled by or driven by AR, just as there is a value to real-estate in the real world locations, there can be inherent value or values for the corresponding virtual real-estate in the virtual spaces. For example, an entity who is a right holder (e.g., owner, renter, sub-lettor, licensor) or is otherwise associated a region of virtual real-estate can control what virtual objects can be placed into that virtual real-estate.

The entity that is the rightholder of the virtual real-state can control the content or objects (e.g., virtual objects) that can be placed in it, by whom, for how long, etc. As such, the disclosed technology includes a marketplace (e.g., as run by server 100 of FIG. 1) to facilitate exchange of virtual real-estate (VRE) such that entities can control object or content placement to a virtual space that is associated with a physical space.

Embodiments of the present disclosure further include systems, methods and apparatuses of seamless integration of augmented, alternate, virtual, and/or mixed realities with physical realities for enhancement of web, mobile and/or other digital experiences. Embodiments of the present disclosure further include systems, methods and apparatuses to facilitate physical and non-physical interaction/action/reactions between alternate realities. Embodiments of the present disclosure also systems, methods and apparatuses of multidimensional mapping of universal locations or location ranges for alternate or augmented digital experiences. Yet further embodiments of the present disclosure include systems, methods and apparatuses to create real world value and demand for virtual spaces via an alternate reality environment.

The disclosed platform enables and facilitates authoring, discovering, and/or interacting with virtual objects (VOBs). One example embodiment includes a system and a platform that can facilitate human interaction or engagement with virtual objects (hereinafter, ‘VOB,’ or ‘VOBs’) in a digital realm (e.g., an augmented reality environment (AR), an alternate reality environment (AR), a mixed reality environment (MR) or a virtual reality environment (VR)). The human interactions or engagements with VOBs in or via the disclosed environment can be integrated with and bring utility to everyday lives through integration, enhancement or optimization of our digital activities such as web browsing, digital (online, or mobile shopping) shopping, socializing (e.g., social networking, sharing of digital content, maintaining photos, videos, other multimedia content), digital communications (e.g., messaging, emails, SMS, mobile communication channels, etc.), business activities (e.g., document management, document procession), business processes (e.g., IT, HR, security, etc.), transportation, travel, etc.

The disclosed innovation provides another dimension to digital activities through integration with the real world environment and real world contexts to enhance utility, usability, relevancy, and/or entertainment or vanity value through optimized contextual, social, spatial, temporal awareness and relevancy. In general, the virtual objects depicted via the disclosed system and platform. can be contextually (e.g., temporally, spatially, socially, user-specific, etc.) relevant and/or contextually aware. Specifically, the virtual objects can have attributes that are associated with or relevant real world places, real world events, humans, real world entities, real world things, real world objects, real world concepts and/or times of the physical world, and thus its deployment as an augmentation of a digital experience provides additional real life utility.

Note that in some instances, VOBs can be geographically, spatially and/or socially relevant and/or further possess real life utility. In accordance with embodiments of the present disclosure, VOBs can be or appear to be random in appearance or representation with little to no real world relation and have little to marginal utility in the real world. It is possible that the same VOB can appear random or of little use to one human user while being relevant in one or more ways to another user in the AR environment or platform.

The disclosed platform enables users to interact with VOBs and deployed environments using any device (e.g., devices 102A-N in the example of FIG. 1), including by way of example, computers, PDAs, phones, mobile phones, tablets, head mounted devices, goggles, smart watches, monocles, smart lens, smart watches and other smart apparel (e.g., smart shoes, smart clothing), and any other smart devices.

In one embodiment, the disclosed platform includes an information and content in a space similar to the World Wide Web for the physical world. The information and content can be represented in 3D and or have 360 or near 360 degree views. The information and content can be linked to one another by way of resource identifiers or locators. The host server (e.g., host server 100 as depicted in the example of FIG. 1) can provide a browser, a hosted server, and a search engine, for this new Web.

Embodiments of the disclosed platform enables content (e.g., VOBs, third party applications, AR-enabled applications, or other objects) to be created and placed into layers (e.g., components of the virtual world, namespaces, virtual world components, digital namespaces, etc.) that overlay geographic locations by anyone, and focused around a layer that has the highest number of audience (e.g., a public layer). The public layer can in some instances, be the main discovery mechanism and source for advertising venue for monetizing the disclosed platform.

In one embodiment, the disclosed platform includes a virtual world that exists in another dimension superimposed on the physical world. Users can perceive, observe, access, engage with or otherwise interact with this virtual world via a user interface (e.g., user interface 104A-N as depicted in the example of FIG. 1) of client application (e.g., accessed via using a user device, such as devices 102A-N as illustrated in the example of FIG. 1).

One embodiment of the present disclosure includes a consumer or client application component (e.g., as deployed on user devices, such as user devices 102A-N as depicted in the example of FIG. 1) which is able to provide geo-contextual awareness to human users of the AR environment and platform. The client application can sense, detect or recognize virtual objects and/or other human users, actors, non-player characters or any other human or computer participants that are within range of their physical location, and can enable the users to observe, view, act, interact, react with respect to the VOBs.

Furthermore, embodiments of the present disclosure further include an enterprise application (which can be desktop, mobile or browser based application). In this case, retailers, advertisers, merchants or third party e-commerce platforms/sites/providers can access the disclosed platform through the enterprise application which enables management of paid advertising campaigns deployed via the platform.

Users (e.g., users 116A-N of FIG. 1) can access the client application which connects to the host platform (e.g., as hosted by the host server 100 as depicted in the example of FIG. 1). The client application enables users (e.g., users 116A-N of FIG. 1) to sense and interact with virtual objects (“VOBs”) and other users (“Users”), actors, non-player characters, players, or other participants of the platform. The VOBs can be marked or tagged (by QR code, other bar codes, or image markers) for detection by the client application.

One example of an AR environment deployed by the host (e.g., the host server 100 as depicted in the example of FIG. 1) enables users to interact with virtual objects (VOBs) or applications related to shopping and retail in the physical world or online/e-commerce or mobile commerce. Retailers, merchants, commerce/e-commerce platforms, classified ad systems, and other advertisers will be able to pay to promote virtual objects representing coupons and gift cards in physical locations near or within their stores. Retailers can benefit because the disclosed platform provides a new way to get people into physical stores. For example, this can be a way to offer VOBs can are or function as coupons and gift cards that are available or valid at certain locations and times.

Additional environments that the platform can deploy, facilitate, or augment can include for example AR-enabled games, collaboration, public information, education, tourism, travel, dining, entertainment etc.

The seamless integration of real, augmented and virtual for physical places/locations in the universe is a differentiator. In addition to augmenting the world, the disclosed system also enables an open number of additional dimensions to be layered over it and, some of them exist in different spectra or astral planes. The digital dimensions can include virtual worlds that can appear different from the physical world. Note that any point in the physical world can index to layers of virtual worlds or virtual world components at that point. The platform can enable layers that allow non-physical interactions.

FIG. 1 illustrates an example block diagram of a host server 100 able to deploy and target context-aware virtual objects and/or to model behavior of virtual objects based on physical principles, in accordance with embodiments of the present disclosure.

The client devices 102A-N can be any system and/or device, and/or any combination of devices/systems that is able to establish a connection with another device, a server and/or other systems. Client devices 102A-N each typically include a display and/or other output functionalities to present information and data exchanged between among the devices 102A-N and the host server 100.

For example, the client devices 102A-N can include mobile, hand held or portable devices or non-portable devices and can be any of, but not limited to, a server desktop, a desktop computer, a computer cluster, or portable devices including, a notebook, a laptop computer, a handheld computer, a palmtop computer, a mobile phone, a cell phone, a smart phone, a PDA, a Blackberry device, a Treo, a handheld tablet (e.g. an iPad, a Galaxy, Xoom Tablet, etc.), a tablet PC, a thin-client, a hand held console, a hand held gaming device or console, an iPhone, a wearable device, a head mounted device, a smart watch, a goggle, a smart glasses, a smart contact lens, and/or any other portable, mobile, hand held devices, etc. The input mechanism on client devices 102A-N can include touch screen keypad (including single touch, multi-touch, gesture sensing in 2D or 3D, etc.), a physical keypad, a mouse, a pointer, a track pad, motion detector (e.g., including 1-axis, 2-axis, 3-axis accelerometer, etc.), a light sensor, capacitance sensor, resistance sensor, temperature sensor, proximity sensor, a piezoelectric device, device orientation detector (e.g., electronic compass, tilt sensor, rotation sensor, gyroscope, accelerometer), eye tracking, eye detection, pupil tracking/detection, or a combination of the above.

The client devices 102A-N, application publisher/developer 108A-N, its respective networks of users, a third party content provider 112, and/or promotional content server 114, can be coupled to the network 106 and/or multiple networks. In some embodiments, the devices 102A-N and host server 100 may be directly connected to one another. The alternate, augmented provided or developed by the application publisher/developer 108A-N can include any digital, online, web-based and/or mobile based environments including enterprise applications, entertainment, games, social networking, e-commerce, search, browsing, discovery, messaging, chatting, and/or any other types of activities (e.g., network-enabled activities).

In one embodiment, the host server 100 is operable to deploy virtual objects that are context-aware to a target environment (e.g., as depicted or deployed via user devices 102A-N). The host server 100 can also model behaviors of virtual objects based on physical principles or physical laws for presentation to a user 116A-N via a user device 102A-N. The host server 100 can further provide an augmented reality workspace in a physical space to be observed or interacted with by users 116A-N. The augmented reality workspace can be one or more applications developed or published in part or in whole by application publisher/developer 108A-N and/or content provider 112. The augmented reality workspace can also be one or more applications provided or developed or published by the host server 100.

In one embodiment, the disclosed framework includes systems and processes for enhancing the web and its features with augmented reality. Example components of the framework can include:
Browser (mobile browser, mobile app, web browser, etc.)
Servers and namespaces the host (e.g., host server 100 can host the servers and namespaces. The content (e.g, VOBs, any other digital object), applications running on, with, or integrated with the disclosed platform can be created by others (e.g., third party content provider 112, promotions content server 114 and/or application publisher/developers 108A-N, etc.).
Advertising system (e.g., the host server 100 can run an advertisement/promotions engine through the platform and any or all deployed augmented reality, alternate reality, mixed reality or virtual reality environments)
Commerce (e.g., the host server 100 can facilitate transactions in the network deployed via any or all deployed augmented reality, alternate reality, mixed reality or virtual reality environments and receive a cut. A digital token or digital currency (e.g., crypto currency) specific to the platform hosted by the host server 100 can also be provided or made available to users.)
Search and discovery (e.g., the host server 100 can facilitate search, discovery or search in the network deployed via any or all deployed augmented reality, alternate reality, mixed reality or virtual reality environments)
Identities and relationships (e.g., the host server 100 can facilitate social activities, track identifies, manage, monitor, track and record activities and relationships between users 116A).

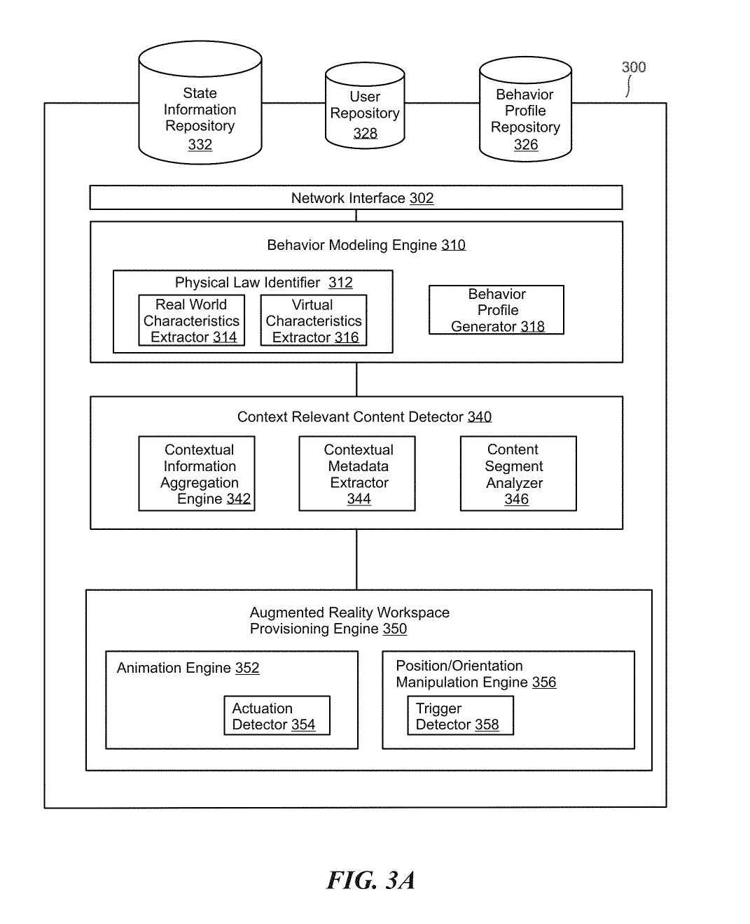

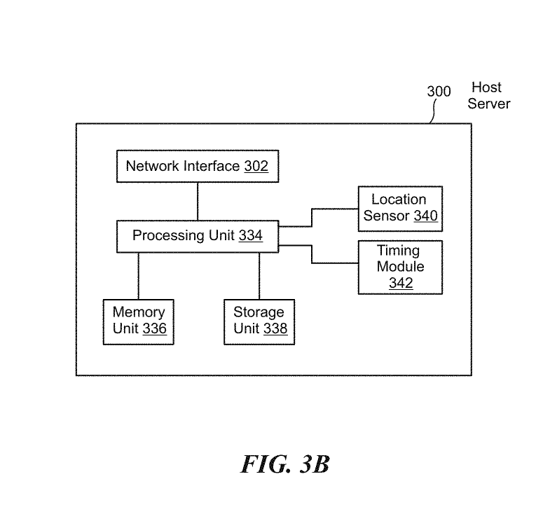

Functions and techniques performed by the host server 100 and the components therein are described in detail with further references to the examples of FIG. 3A-3B.

In general, network 106, over which the client devices 102A-N, the host server 100, and/or various application publisher/provider 108A-N, content server/provider 112, and/or promotional content server 114 communicate, may be a cellular network, a telephonic network, an open network, such as the Internet, or a private network, such as an intranet and/or the extranet, or any combination thereof. For example, the Internet can provide file transfer, remote log in, email, news, RSS, cloud-based services, instant messaging, visual voicemail, push mail, VoIP, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 106 can be any collection of distinct networks operating wholly or partially in conjunction to provide connectivity to the client devices 102A-N and the host server 100 and may appear as one or more networks to the serviced systems and devices. In one embodiment, communications to and from the client devices 102A-N can be achieved by an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more networks, such as, but are not limited to, one or more of WiMax, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), enabled with technologies such as, by way of example, Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G, 5G, IMT-Advanced, pre-4G, 3G LTE, 3GPP LTE, LTE Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, UMTS-TDD, 1×RTT, EV-DO, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The host server 100 may include internally or be externally coupled to a user repository 128, a virtual object repository 130, a behavior profile repository 126, a metadata repository 124, an analytics repository 122 and/or a state information repository 132. The repositories can store software, descriptive data, images, system information, drivers, and/or any other data item utilized by other components of the host server 100 and/or any other servers for operation. The repositories may be managed by a database management system (DBMS), for example but not limited to, Oracle, DB2, Microsoft Access, Microsoft SQL Server, PostgreSQL, MySQL, FileMaker, etc.

The repositories can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package.

In some embodiments, the host server 100 is able to generate, create and/or provide data to be stored in the user repository 128, the virtual object (VOB) repository 130, the behavior model repository 126, the metadata repository 124, the analytics repository 122 and/or the state information repository 132. The user repository 128 and/or analytics repository 122 can store user information, user profile information, demographics information, analytics, statistics regarding human users, user interaction, brands advertisers, virtual object (or ‘VOBs’), access of VOBs, usage statistics of VOBs, ROI of VOBs, etc.

The virtual object repository 130 can store virtual objects and any or all copies of virtual objects. The VOB repository 130 can store virtual content or VOBs that can be retrieved for consumption in a target environment, where the virtual content or VOBs are contextually relevant. The VOB repository 130 can also include data which can be used to generate (e.g., generated in part or in whole by the host server 100 and/or locally at a client device 102A-N) contextually-relevant or aware virtual content or VOB(s).

The metadata repository 124 is able to store virtual object metadata of data fields, identification of VOB classes, virtual object ontologies, virtual object taxonomies, etc. One embodiment further includes the state information repository 132 which can store state data, or state metadata, or state information relating to various animation states of a given VOB or a group of VOBs. The state information repository 132 can store identifications of the number of states associated with any VOB, metadata regarding animation details of each given animation state, and/or rendering metadata of each given animation state for any VOB for the host server 100 or client device 102A-N to render, create or generate the VOBs and their associated animations in different animation states.

The behavior profile repository 126 can store behavior profiles including behavioral characteristics of VOBs or other virtual content. In general, the behavior profile are generated using physical principles or physical laws of the real world.

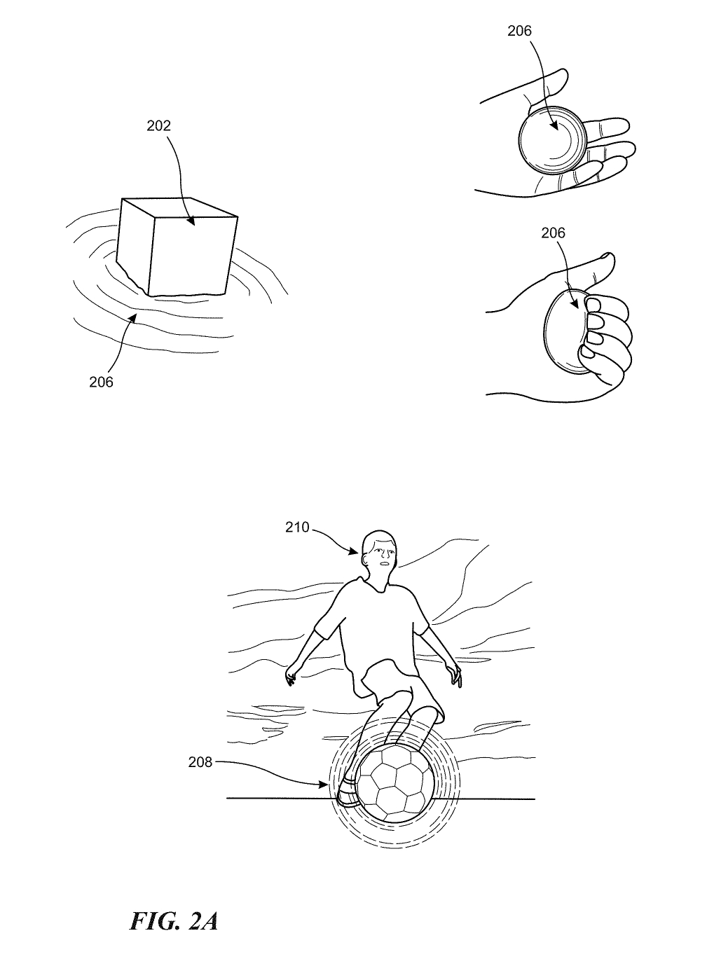

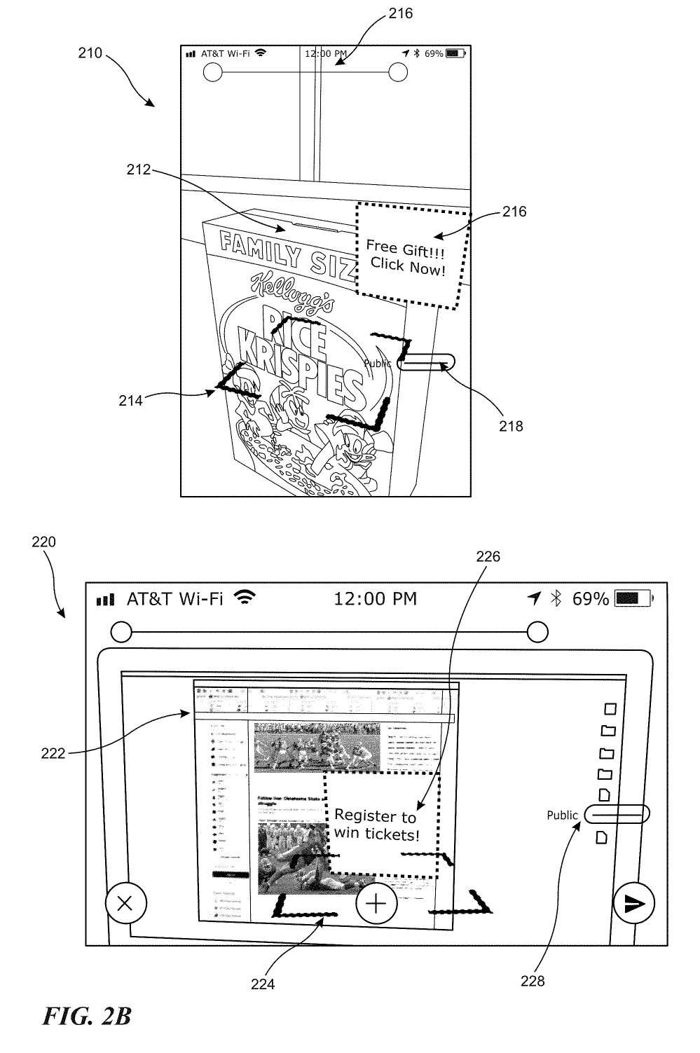

FIG. 2A depicts example diagrams of virtual objects (VOBs) with behavior characteristics governed by physical laws of the real world, in accordance with embodiments of the present disclosure.

Virtual objects can be implemented to behave like real world physical objects. For example, virtual object behavior simulation or modeling can be implemented based on physical laws or physical, material, mechanical, electrical, optical and/or chemical properties.

Depending on specific settings of the location and/or the objects they can obey differing physical laws or have differing physical properties. For example, if the gravity in a location is strong or weak objects may float towards the ground or ceiling or may hover in place. If VOBs are treated as heavier or lighter than air they may also drift downwards or upwards. A VOB 202 can be depicted to be floating on a body of liquid or partially or fully sink into the liquid 206 depending on the material which the VOB simulates and/or the type of liquid the body of water is or simulates, and the relative densities for example of the VOB material and the type of liquid. If the VOBs are allowed to drift or glide as if in a zero gravity or microgravity environment they can continue to move in a direction until something stops them or pushes them in another direction, or they can spin or tumble or otherwise behave like physical objects or particles floating in space.

When touched or interacted with they can respond in a physically appropriate way depending on their mass and the physical laws of the location and other properties of the objects, surface properties, material properties, optical properties, mechanical properties, and/or the level and type of force exerted on them. For example, VOB 206 is modeled in accordance with mechanical properties governing the apparent elasticity. When the user squeezes or performs a squeezing action or squeezing gesture, the VOB 206 via the AR environment, can be depicted as being compressed. In addition, audio characteristics may be rendered in association with the depicted animation and/or with the gesture/action or other gestures.

Virtual objects may also interact with other virtual objects, colliding with them and bouncing off of them. For example, if two billboards bump into each other, does one occlude the other, they may penetrate and go through each other like ghosts. They can also bounce off of each other. In some embodiments, virtual objects such as Billboards can be tethered near locations like balloons such that they remain within the vicinity of the tether point, stuck to locations temporarily like magnets such that they don't move until unstuck, or glued to locations permanently. For example, VOB 208 can exhibit behavioral characteristics of a football (soccer ball). When the user 210 (which may be a human user or an actor in an AR environment) kicks or simulates a kick of the VOB 208, it can project in a trajectory like a real football. The associated rendering, in trajectory, flight path, speed/velocity of flight can depend on physical attributes of the kick (speed, direction, force, angle, etc.). Sound for the kick and collision/interaction with the VOB 208 can also be simulated and rendered in the AR environment.

The disclosed platform can further enable a path for a virtual object—such as a circuit it travels on—to be defined. For example, a VOB that says “Follow Me for the Tour” could take users on a tour, perhaps pausing and providing additional information or content at specific points along the tour trajectory, or even interacting with users who follow it along the way. Objects can also be allowed to float freely and simply interact with other real and virtual objects or surfaces in a location.

One embodiment of a VOB includes a magnet object which exhibits or simulates behavioral characteristics of magnetic material. The magnetic object VOB can be used to pull or move nearby objects to a location such as the user's location or a location they want to move them to. In addition, virtual objects can float or move in space or they can move along surfaces, or they can be mapped onto surfaces like walls and floors and ceilings or the sky. They can also be mapped onto the bodies of users or the outsides of other virtual objects. Whether 3D or flat these objects can be activated and opened or closed.

FIG. 2B depicts example diagrams of context-aware virtual objects 216 and 226 that are deployed in a target environment 210 and 220, in accordance with embodiments of the present disclosure.

Target environment 210 can be for example, an augmented reality environment, having a real environment having a physical cereal box 212, a virtual component having a selector 214 (e.g., digital or virtual pointer of a virtual component). The virtual component of the AR environment which is the target environment can further include user interface elements 216 and/or 218. Element 216 can be a slider to adjust the virtualness scale of the AR environment, with a higher virtual scale showing the virtual component with higher human perceptibility and/or the real environment component having lower human perceptibility. At the lower virtual scale, the virtual objects of the virtual component can be shown with lower human perceptibility and/or the real environment component can be shown with higher human perceptibility.

In one embodiment, portions (e.g., content segment) of the physical cereal box 212 can be associated with VOB(s) that are context aware. On detection or selection (e.g., by the pointer 214) of the content segment (e.g., the Rice Krispies label of the cereal box 212) via a user device or imaging unit, the VOB 216 can be rendered in the target environment 210 for consumption by a user.

Similarly, in an AR environment having target environment 220, portions (e.g., a content segment) of the webpage 222 can be associated a VOB 226 that is contextually aware. For example, the platform (e.g., via a user device) can ascertain that content pertaining to airplane ticket sales is being consumed in the target environment 220. The content can be identified or detected for example when the virtual pointer 224 of the virtual component of the AR environment having the target environment 220 detects the content segment. The VOB 226 that is then depicted in the target environment 220 (e.g., an enter to win ticket bulletin) is contextually aware or relevant to the target environment.

User interface elements 218 and 228 are selectors for the different layers of the virtual world component. In addition to the public layer being depicted, there may be private layers (which contain a user's VOBs and may by default be exclusively private to an owner or admin) or group layers.

FIG. 3A depicts an example functional block diagram of a host server 300 that deploys and/or targets context-aware virtual objects and/or models behavior of virtual objects based on physical principles, in accordance with embodiments of the present disclosure.

The host server 300 includes a network interface 302, a behavior modeling engine 310, a context relevant content detector 340, and/or an augmented reality workspace provisioning engine 350. The host server 300 is also coupled to a user repository 328, a state information (VRE) repository 332 and/or a behavior profile repository 326. Each of the behavior modeling engine 310, the context relevant content detector 340, and/or the augmented reality workspace provisioning engine 350. can be coupled to each other.

One embodiment of the behavior modeling engine 310 includes, a physical law identifier 312 having a real world characteristics tracker 314 and/or a virtual characteristics tracker 316, and a behavior profile generator 318. One embodiment of the context relevant content detector 340 includes, a contextual information aggregation engine 342, a contextual metadata extractor 344 and/or content segment analyzer 346. One embodiment of the augmented reality workspace provisioning engine 350 includes, an animation engine 352 having an actuation detector 354 and/or a position/orientation manipulation engine 356 having a trigger detector 358.

Additional or less modules can be included without deviating from the techniques discussed in this disclosure. In addition, each module in the example of FIG. 3A can include any number and combination of sub-modules, and systems, implemented with any combination of hardware and/or software modules.

The host server 300, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

The network interface 302 can be a networking module that enables the host server 300 to mediate data in a network with an entity that is external to the host server 300, through any known and/or convenient communications protocol supported by the host and the external entity. The network interface 302 can include one or more of a network adaptor card, a wireless network interface card (e.g., SMS interface, WiFi interface, interfaces for various generations of mobile communication standards including but not limited to 1G, 2G, 3G, 3.5G, 4G, LTE, 5G, etc.), Bluetooth, a router, an access point, a wireless router, a switch, a multilayer switch, a protocol converter, a gateway, a bridge, bridge router, a hub, a digital media receiver, and/or a repeater.

As used herein, a “module,” a “manager,” an “agent,” a “tracker,” a “handler,” a “detector,” an “interface,” or an “engine” includes a general purpose, dedicated or shared processor and, typically, firmware or software modules that are executed by the processor. Depending upon implementation-specific or other considerations, the module, manager, tracker, agent, handler, or engine can be centralized or have its functionality distributed in part or in full. The module, manager, tracker, agent, handler, or engine can include general or special purpose hardware, firmware, or software embodied in a computer-readable (storage) medium for execution by the processor.

As used herein, a computer-readable medium or computer-readable storage medium is intended to include all mediums that are statutory (e.g., in the United States, under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, flash, optical storage, to name a few), but may or may not be limited to hardware.

One embodiment of the host server 300 includes the behavior modeling engine 310 having the physical law identifier 312 having a real world characteristics tracker 314 and/or a virtual characteristics tracker 316, and a behavior profile generator 318. The behavior modeling engine 310 can be any combination of software agents and/or hardware modules (e.g., including processors and/or memory units) able to model, simulate, determine, behavior models of virtual objects (e.g., VOBs or objects) based on associated behavioral characteristics. The behavior profile generator 318 can generate a behavioral profile for the object modelled based on one or more physical laws of the real world. The behavioral profile includes the behavioral characteristics.

The physical law identifier 312 can identify, detect, derive, determine, extract and/or formulate a physical law or set of physical principles of the real world, in accordance with which, behavioral characteristics of the object in the augmented reality environment are to be governed. the physical laws include, one or more of, laws of nature, a law of gravity, a law of motion, electrical properties, magnetic properties, optical properties, Pascal's principle, laws of reflection or refraction, a law of thermodynamics, Archimedes' principle or a law of buoyancy, mechanical properties of materials; wherein, the mechanical properties of materials include, one or more of: elasticity, stiffness, yield, ultimate tensile strength, ductility, hardness, toughness, fatigue strength, endurance limit

In general, the physical law can be identified based on one or more of: real world characteristics of a real world environment (e.g., by the real world characteristics extractor 314) associated with the augmented reality environment; and/or virtual characteristics of a virtual environment (e.g., by the virtual characteristics extractor 316) in the augmented reality environment. The real world characteristics can include one or more of, (i) natural phenomenon of the real world environment, and characteristics of the natural phenomenon; (ii) physical things of the real world environment, and an action, behavior or characteristics of the physical things; and/or (iii) a human user in the real world environment, and action or behavior of the human user. The virtual world characteristics of the virtual environment, include one or more of, (i) virtual phenomenon of the virtual environment; (ii) characteristics of a natural phenomenon which the virtual phenomenon emulates; (iii) virtual things of the virtual world environment, and action, behavior or characteristics of the virtual things; (iv) a virtual actor in the virtual world environment, and action or behavior of the virtual actor.

In one embodiment, the behavior modelling engine can model behavioral characteristics to include properties or actions of a real world object which the virtual object depicts or represents. For example, a VOB that is a virtual boat can have the floating or movement properties of a real boat, on water. A VOB that is a virtual football (soccer ball) (as illustrated in the example of FIG. 2A) can be modelled as having mechanical properties based on an actual football.

The host server 300 can update the depiction of the virtual object in an AR environment based upon the physical principles or laws. The depiction of the VOB that is updated in the augmented reality environment, includes one or more of, a visual update, an audible update, a sensory update, a haptic update, a tactile update and an olfactory update.

One embodiment of the host server 300 includes the context relevant content detector 340 having the contextual information aggregation engine 342, the contextual metadata extractor 344 and/or the content segment analyzer 346. The content relevant content detector 340 can be any combination of software agents and/or hardware modules (e.g., including processors and/or memory units) able to detect, determine, identify, an indication that a content segment being consumed in the target environment has virtual content that is contextually relevant or aware associated with it.

The content segment can include a segment of one or more of, content in a print magazine, a billboard, a print ad, a board game, a card game, printed text, any printed document. The content segment can also include a segment of one or more of, TV production, TV ad, radio broadcast, a film, a movie, a print image or photograph, a digital image, a video, digitally rendered text, a digital document, any digital production, a digital game, a webpage, any digital publication. A user can be consuming content segment when the content segment is being interacted with (e.g. using a pointer, a cursor, a virtual pointer, virtual tool, via gesture, eye tracker, etc.), being played back, is visible, is audible or is otherwise human perceptible in the target environment.

The indication that the content segment being consumed in the target environment has virtual content associated with it, that can be detected by the detector 340 can include, one or more of a pattern of data embedded in the content segment; visual markers in the content segment, the visual markers being perceptible or imperceptible to a human user; sound markers or a pattern of sound embedded in the content segment, the sound markers being perceptible or imperceptible to a human user. In one embodiment, the indication is determined through analysis of content type of the content segment being consumed, for example by the content segment analyzer 346.

In one embodiment, the detector 340 can detect, identify, capture and/or aggregate contextual information (e.g., via the contextual information aggregation engine 342) for the target environment.

A target environment can for example, include, a TV unit, an entertainment unit, a speaker, a smart speaker, any AI enabled speaker/microphone, a scanning/printing device, a radio, a physical room, a physical environment, a vehicle, a road, any physical location in any arbitrarily defined boundary, a portion of a room, a portion/floor(s) of a building, a browser, a desktop app, a mobile app, a mobile browser, a user interface on any digital device, a mobile display, a laptop display, a smart glass display, a smart watch display, a head mounted device display, any digital device display, physical air space associated with any physical entity (e.g., physical thing, person, place or landmark) etc.

Contextual information that can be aggregated by engine 342 can include, one or more of: identifier of a device used to consume the content segment in the target environment; timing data associated with consumption of the content segment in the target environment; software on the device; cookies on the device; indications of other virtual objects on the device. The contextual information can also include, one or more of: identifier of a human user in the target environment; timing data associated with consumption of the content segment in the target environment; interest profile of the human user; behavior patterns of the human user; pattern of consumption of the content segment; attributes of the content segment. The contextual information can also include for instance, one or more of: pattern of consumption of the content segment; attributes of the content segment; location data associated with the target environment; timing data associated with the consumption of the content segment.

Contextual metadata can be detected, identified, or extracted (e.g., by the contextual metadata extractor 344) from the contextual information. The contextual metadata can be used to generate the virtual content that is presented for consumption, based on contextual metadata in the contextual information. The virtual content that is associated with the content segment and presented in the target environment can be generated on demand. The contextual metadata can also be used to retrieve the virtual content that is presented for consumption. For example, the virtual content is retrieved at least in part from a remote repository in response to querying the remote repository using the contextual metadata.

One embodiment of the host server 300 includes the augmented reality workspace provisioning engine 350 having the animation engine 352 having the actuation detector 354 and/or the position/orientation manipulation engine 356 having the trigger detector 358.

The augmented reality workspace provisioning engine 350 can be any combination of software agents and/or hardware modules (e.g., including processors and/or memory units) able to generate, manage, control, display, provision, activate, and/or deploy an augmented reality workspace in a physical space. The augmented reality workspace provisioning engine 350 can further include, the animation engine 352 having the actuation detector 354 and/or the position/orientation manipulation engine 356 having the trigger detector 358.

The provisioning engine 350 can render a virtual object as a user interface element of the augmented reality workspace. The user interface element of the augmented reality workspace can be rendered as being present in the physical space and able to be interacted with in the physical space. The user interface element represented by the virtual object includes by way of example, a folder, a file, a data record, a document, an application, a system file, a trash can, a pointer, a menu, a task bar, a launch pad, a dock, a lasso tool

The virtual object is rendered in a first animation state (e.g., as tracked or determined by the animation engine 352), in accordance with state information associated with the virtual object. The animation engine 352 can transition the virtual object into a second animation state in the AR workspace, for example, in response to detection of actuation of the virtual object (e.g., by the actuation detector 354).

The actuation can be detected from (e.g., by the actuation detector 354) one or more of, an image based sensor, a haptic or tactile sensor, a sound sensor or a depth sensor. The actuation can also be detected (e.g., by the actuation detector 354) from input submitted via, one or more of, a virtual laser pointer, a virtual pointer, a lasso tool, a gesture sequence of a human user in the physical space.

In a further embodiment, a position or orientation of the virtual object in the augmented reality workspace can be changed (e.g., by the position/orientation engine 356), responsive to a shift in view perspective of the augmented reality workspace.

The shift in the view perspective can be triggered by a motion of, one or more of: a user of the augmented reality work space and/or a device used to access the augmented reality workspace. The motion can be detected by the trigger detector 358 for instance. A speed or acceleration of the motion can also be detected by trigger detector 358. Note that acceleration or speed of the change of the position or orientation of the virtual object can depend on a speed or acceleration of the motion of the user or the device

FIG. 3B depicts an example block diagram illustrating the components of the host server 300 that deploys and/or targets context-aware virtual objects and/or models behavior of virtual objects based on physical principles or laws of physics, in accordance with embodiments of the present disclosure.

In one embodiment, host server 300 includes a network interface 302, a processing unit 334, a memory unit 336, a storage unit 338, a location sensor 340, and/or a timing module 342. Additional or less units or modules may be included. The host server 300 can be any combination of hardware components and/or software agents for to facilitate trade or exchange of virtual real-estate associated with a physical space. The network interface 302 has been described in the example of FIG. 3A.

One embodiment of the host server 300 includes a processing unit 334. The data received from the network interface 302, location sensor 340, and/or the timing module 342 can be input to a processing unit 334. The location sensor 340 can include GPS receivers, RF transceiver, an optical rangefinder, etc. The timing module 342 can include an internal clock, a connection to a time server (via NTP), an atomic clock, a GPS master clock, etc.

The processing unit 334 can include one or more processors, CPUs, microcontrollers, FPGAs, ASICs, DSPs, or any combination of the above. Data that is input to the host server 300 can be processed by the processing unit 334 and output to a display and/or output via a wired or wireless connection to an external device, such as a mobile phone, a portable device, a host or server computer by way of a communications component.

One embodiment of the host server 300 includes a memory unit 336 and a storage unit 338. The memory unit 335 and a storage unit 338 are, in some embodiments, coupled to the processing unit 334. The memory unit can include volatile and/or non-volatile memory. In virtual object deployment, the processing unit 334 may perform one or more processes related to targeting of context-aware virtual objects in AR environments. The processing unit 334 can also perform one or more processes related to behavior modeling of virtual objects based on physical principles or physical laws.

In some embodiments, any portion of or all of the functions described of the various example modules in the host server 300 of the example of FIG. 3A can be performed by the processing unit 334.

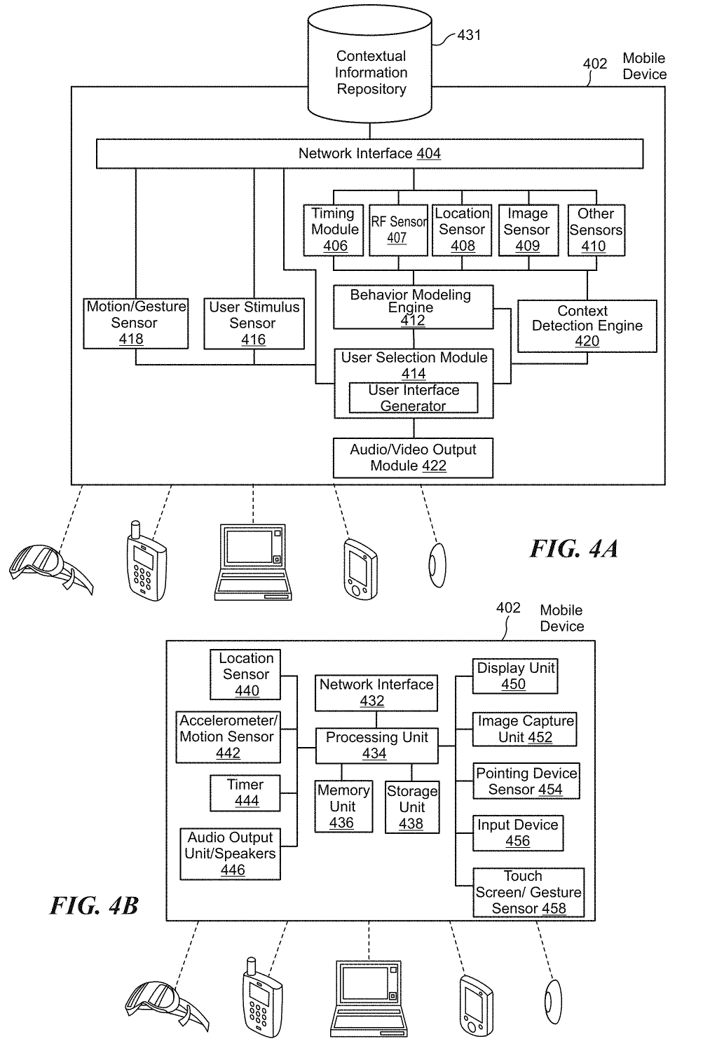

FIG. 4A depicts an example functional block diagram of a client device 402 such as a mobile device that captures contextual information for a target environment and/or presents virtual objects with characteristics modeled based on physical laws of the real world, in accordance with embodiments of the present disclosure.

The client device 402 includes a network interface 404, a timing module 406, an RF sensor 407, a location sensor 408, an image sensor 409, a behavior modeling engine 412, a user selection module 414, a user stimulus sensor 416, a motion/gesture sensor 418, a context detection engine 420, an audio/video output module 422, and/or other sensors 410. The client device 402 may be any electronic device such as the devices described in conjunction with the client devices 102A-N in the example of FIG. 1 including but not limited to portable devices, a computer, a server, location-aware devices, mobile phones, PDAs, laptops, palmtops, iPhones, cover headsets, heads-up displays, helmet mounted display, head-mounted display, scanned-beam display, smart lens, monocles, smart glasses/goggles, wearable computer such as mobile enabled watches or eyewear, and/or any other mobile interfaces and viewing devices, etc.

In one embodiment, the client device 402 is coupled to a contextual information repository 431. The contextual information repository 431 may be internal to or coupled to the mobile device 402 but the contents stored therein can be further described with reference to the example of the contextual information repository 132 described in the example of FIG. 1.

Additional or less modules can be included without deviating from the novel art of this disclosure. In addition, each module in the example of FIG. 4A can include any number and combination of sub-modules, and systems, implemented with any combination of hardware and/or software modules.

The client device 402, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

In the example of FIG. 4A, the network interface 404 can be a networking device that enables the client device 402 to mediate data in a network with an entity that is external to the host server, through any known and/or convenient communications protocol supported by the host and the external entity. The network interface 404 can include one or more of a network adapter card, a wireless network interface card, a router, an access point, a wireless router, a switch, a multilayer switch, a protocol converter, a gateway, a bridge, bridge router, a hub, a digital media receiver, and/or a repeater.

According to the embodiments disclosed herein, the client device 402 can render or present a virtual object in a target environment that is contextually aware and/or render an augmented reality workspace in a physical space.

The AR workspace can also be rendered at least in part via one or more of, a mobile browser, a mobile application and a web browser, e.g., via the client device 402. Note that the marketplace environment can be rendered in part of in whole in a hologram, for example, in 3D and in 360 degrees, via the client device 402.

The client device 402 can provide functionalities described herein via a consumer client application (app) (e.g., consumer app, client app. Etc.). The consumer application includes a user interface that enables entities to view, access, interact with the context aware virtual objects and/or objects that have been modeled based on physical principles or physical laws (e.g., by the behavior modeling engine 412). The context detection engine 420 can for example capture contextual information for a target environment in which the context aware virtual objects are to be deployed.

FIG. 4B depicts an example block diagram of the client device 402, which can be a mobile device that captures contextual information for a target environment and/or presents virtual objects with characteristics modeled based on physical laws of the real world, in accordance with embodiments of the present disclosure.

In one embodiment, client device 402 (e.g., a user device) includes a network interface 432, a processing unit 434, a memory unit 436, a storage unit 438, a location sensor 440, an accelerometer/motion sensor 442, an audio output unit/speakers 446, a display unit 450, an image capture unit 452, a pointing device/sensor 454, an input device 456, and/or a touch screen sensor 458. Additional or less units or modules may be included. The client device 402 can be any combination of hardware components and/or software agents for capturing contextual information for a target environment and/or presenting or rendering virtual objects with characteristics modeled based on physical laws of the real world. The network interface 432 has been described in the example of FIG. 4A.

One embodiment of the client device 402 further includes a processing unit 434. The location sensor 440, accelerometer/motion sensor 442, and timer 444 have been described with reference to the example of FIG. 4A.

The processing unit 434 can include one or more processors, CPUs, microcontrollers, FPGAs, ASICs, DSPs, or any combination of the above. Data that is input to the client device 402 for example, via the image capture unit 452, pointing device/sensor 554, input device 456 (e.g., keyboard), and/or the touch screen sensor 458 can be processed by the processing unit 434 and output to the display unit 450, audio output unit/speakers 446 and/or output via a wired or wireless connection to an external device, such as a host or server computer that generates and controls access to simulated objects by way of a communications component.

One embodiment of the client device 402 further includes a memory unit 436 and a storage unit 438. The memory unit 436 and a storage unit 438 are, in some embodiments, coupled to the processing unit 434. The memory unit can include volatile and/or non-volatile memory. In rendering or presenting an augmented reality environment, the processing unit 434 can perform one or more processes related to administering an augmented reality workspace in a physical space where a user interface element of the augmented reality workspace is rendered as being present in the physical space and able to be interacted with in the physical space.

In some embodiments, any portion of or all of the functions described of the various example modules in the client device 402 of the example of FIG. 4A can be performed by the processing unit 434. In particular, with reference to the mobile device illustrated in FIG. 4A, various sensors and/or modules can be performed via any of the combinations of modules in the control subsystem that are not illustrated, including, but not limited to, the processing unit 434 and/or the memory unit 436.

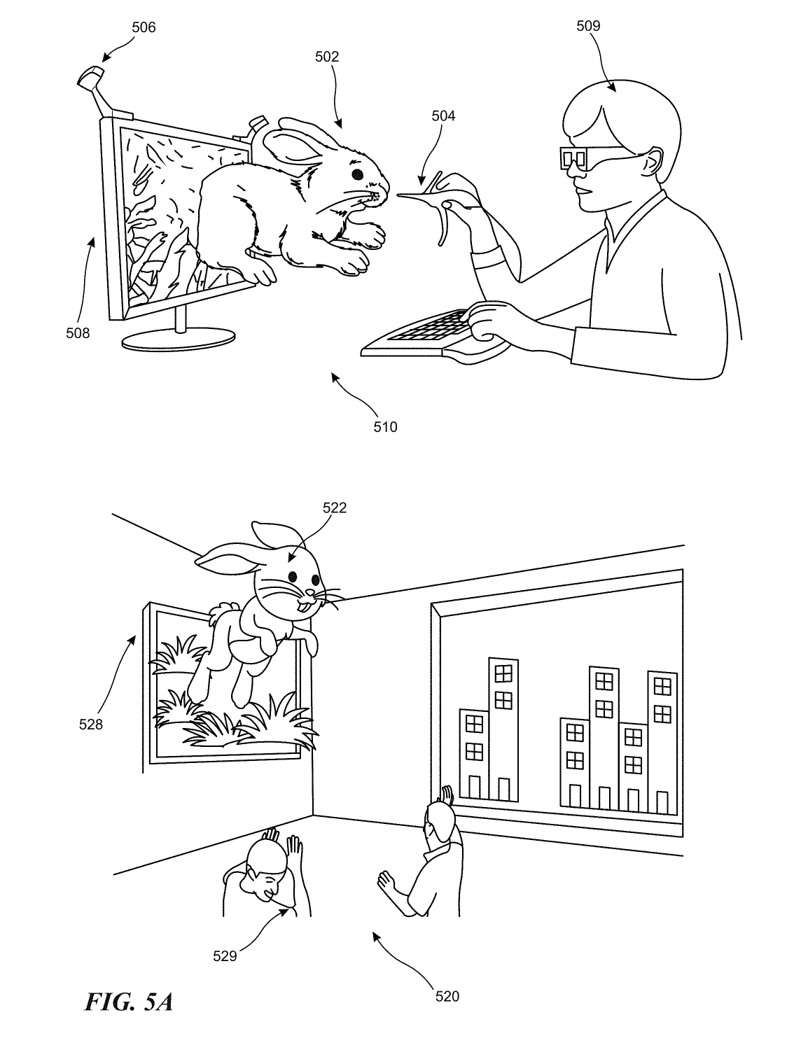

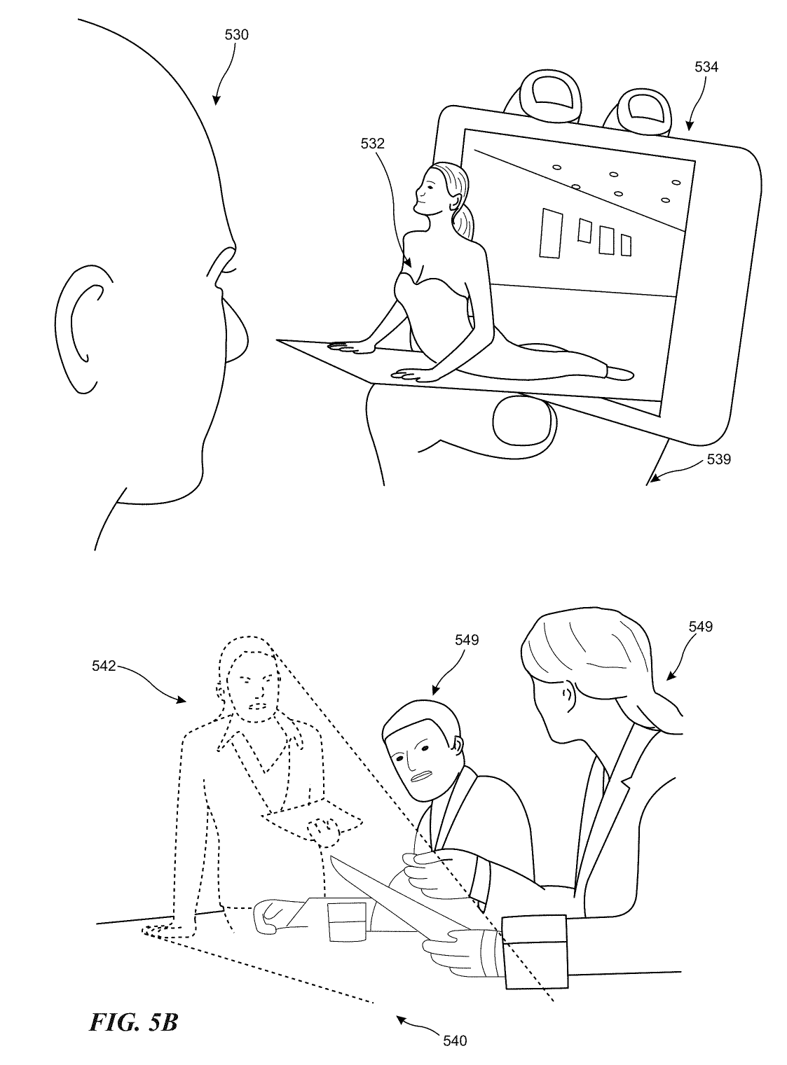

FIG. 5A-5B graphically depicts views of examples of virtual objects that are context aware to a target environment in physical space in which they are deployed and/or virtual objects which are modeled based on physical laws or principles, in accordance with embodiments of the present disclosure.

In one embodiment, virtual objects (e.g., VOB 502 or VOB 522 or VOB 532 or VOB 542) can be made to appear when certain content appears on a TV or other screen (e.g., screen 508 or 528). A special symbol or pattern can appear on the screen, or a sound can be played, or a timing parameter can generate a timecode, and this can trigger the appearance of particular virtual objects for that content. Also, virtual objects (g., VOB 502 or VOB 522 or VOB 532 or VOB 542) can appear to hover over or come out of a device screen (e.g., mobile device, laptop, or computer screen) into the physical space in relation to content appearing on that screen or activities taking place in software or content on that screen (e.g., the target environment). VOB Imaging units 506 can be used to capture user commands that determine interaction with the VOBs.

The VOBs (e.g., VOB 502 or VOB 522 or VOB 532 or VOB 542) can be depicted in an augmented reality interface via one or more of, a mobile phone, a glasses, a smart lens and a headset device for example, in 3D in a physical space and the virtual object is viewable in substantially 360 degrees.

For example, when an ad plays, virtual objects (.g., VOB 502 or VOB 522 or VOB 532 or VOB 542) related to the ad (e.g., or a portion of the ad, or content segment) can appear to come out of a portable device, its screen or a TV screen or appear near the device or TV screen and then move around the viewer's living room (the target environment). When the ad ends they can remain or go back into the TV. The same can happen during a movie or pre-recorded or live content event. Virtual objects can also appear contextually at times and places, such as at dinner time in the kitchen or right on the stove or near the bar or a particular consumer packaged goods product like a can of soda or a bottle of beer or box of cereal.

Virtual objects can also be generated to appear near or from content or consumer packaged goods (e.g., as shown in the example of FIG. 2A) objects or other physical products, things, or places, based on algorithms that determine what to show based on location, time of day, date, user profile and interests, or other contextual cues such as weather or events taking place or sound or sensor data about what is happening in that location or with that object. End users can configure these settings, or they can be set by advertisers, another third party or the platform.

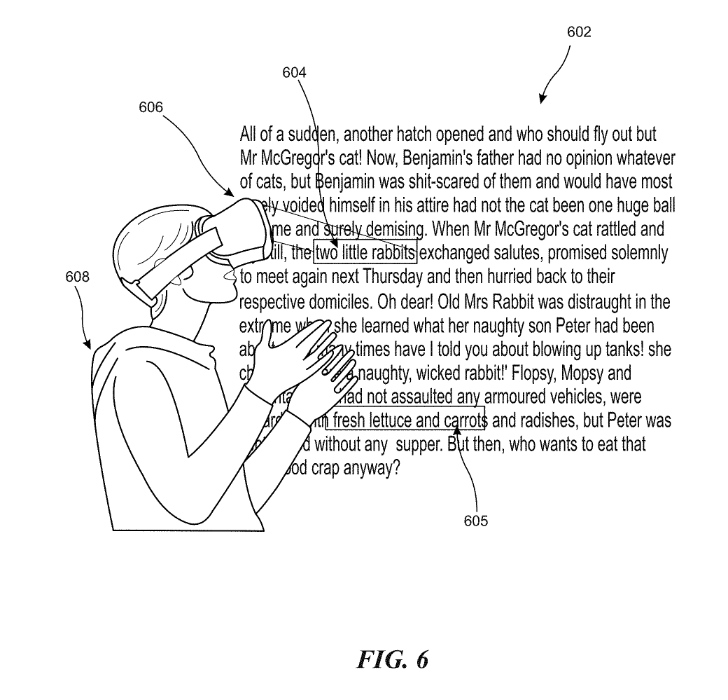

FIG. 6 graphically depicts an example of a content segment 604 or 605 being consumed, that is associated with a virtual object (e.g, the rabbit VOB 502 or rabbit VOB 522 of FIG. 5B), in accordance with embodiments of the present disclosure.

For example, the human user 608 can be can be viewing or reading a document, publication containing text 605. Via the user device 606, it can be detected that some of the content segments (e.g., text portions 604 and 605) of a document, article, webpage, publication or other body of text 602 have associated VOBs. When the user device 606 detects that text portions 604 and/or 605 are being consumed (e.g., read by the user 608 or viewed or is in a field of view, or selected or actuated by the user 608 via device 606), associated VOBs which can be context relevant or aware can be rendered or depicted in the target environment (e.g., the rabbit VOB 502 or rabbit VOB 522 as illustrated in the example of FIG. 5B). The VOB can also be rendered by user device 606.

The VOB can perform some predetermined animation or audio playback or live audio, the VOB can also be interacted with by human users in the target environment. The VOB can disappear (e.g., vanish in thin air) or appear to return to the device screen (e.g., device 606 or screens 508 or 528). Note that body of text 602 can be digital or analog, or be physically in print (e.g., book, poster, paper, magazine etc).

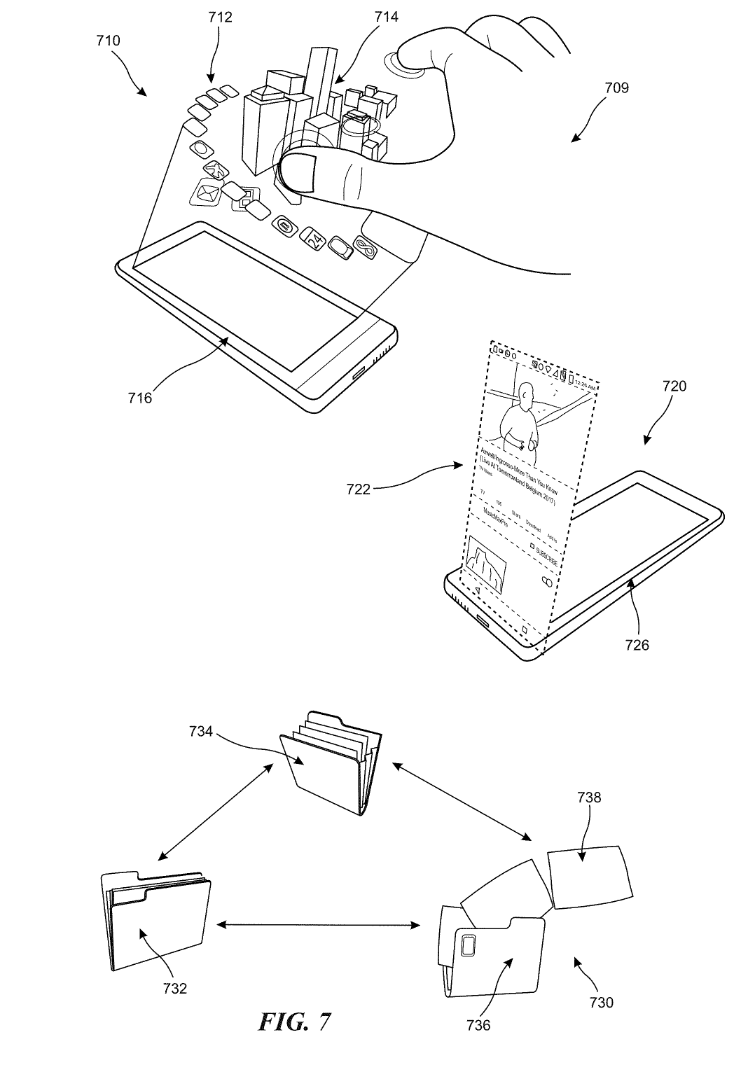

FIG. 7 graphically depicts a view of an example of an augmented reality workspace 710 or 720 and virtual objects 730 with multiple animation states (732, 734 and/or 736), in accordance with embodiments of the present disclosure.

The augmented reality workspace 710 can include VOBs that are user interface elements such as mobile icons or desktop icons or other content 714 that can be rendered to be projecting out of the screen of the device 716 or 722. Additional user interface elements can include for example one or more of, a folder (e.g., folder 730, a file (e.g., file 738), a data record, a document, an application, a system file, a trash can, a pointer, a menu, a task bar, a launch pad, a dock, a lasso tool.

The user 709 can interact with any of the user interface elements 714, The user can also consume or interact with the content 714 or 744, for example, through verbal instructions, text input, submission through a physical controller, eye movements, body movements, physical gestures, or using a virtual controller.

Note that VOBs such as the folder 730 can exhibit different animation states 732, 734 and 736. VOBs such as the folder 730 can also be a container object which includes one or more other virtual objects. For example, the folder object 730 can contain the paper objects 738 which can be revealed on selection or other actuation of the VOB 730, for any stage of progression of animation for the virtual object 730.

In general, the augmented reality workspace can be depicted in an augmented reality interface via one or more of, a mobile phone, a glasses, a smart lens and a headset device; wherein, augmented reality workspace is depicted in 3D in the physical space and the virtual object is viewable in substantially 360 degrees

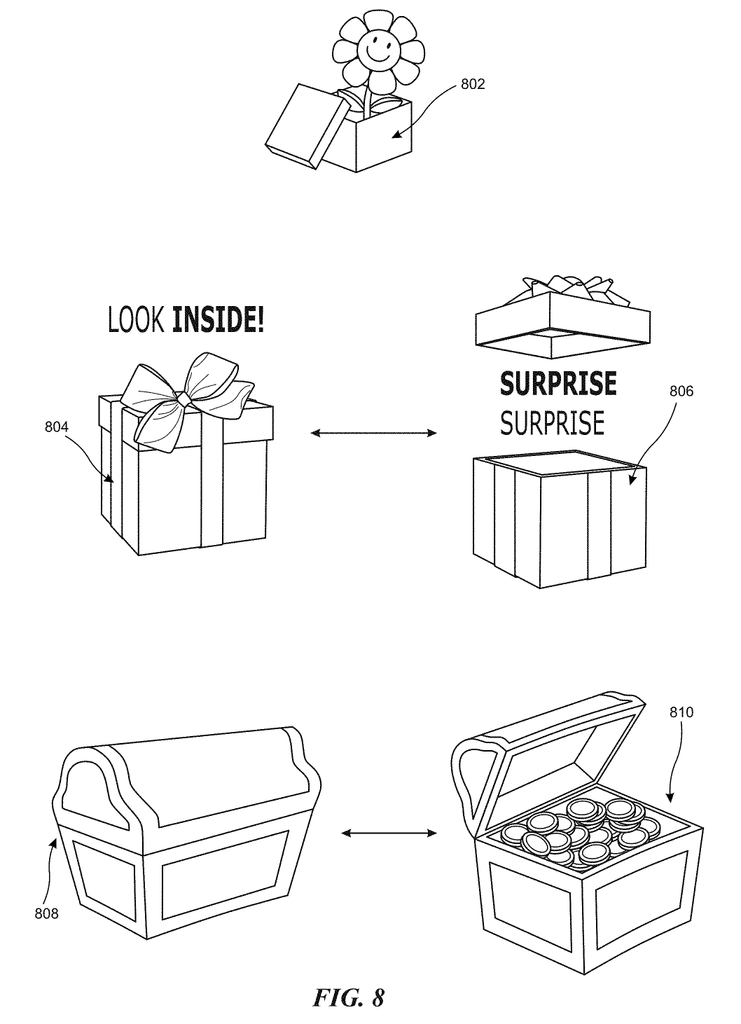

FIG. 8 graphically depicts examples of virtual objects 802, 804, 808 (object, VOB) that function as containers, in accordance with embodiments of the present disclosure.

A virtual object can be opened or closed, or expanded or collapsed if it is a container. It can behave like a folder or a wallet or a gift box 804 or a backpack or a drawer or a treasure chest (e.g., 810), for example. A virtual object can be picked up by a user and later dropped somewhere else, or given to another user. A VOB can also be shared, moved, modified, annotated with metadata.

Another object can be put into a container object or moved out of it and put into the space outside a container object such as object 802. A user can go inside a container object and when they are inside it this can be rendered as a virtual world or portal around the user. An object can be activated to reveal content such object 804. An object can also be activated to reveal additional objects 808.

In some embodiments, a category of activity or objects at a place can be represented by a container object. When the object is opened all or some of its contained activity or objects appear. When it is closed they go back into it. A hierarchy of container objects can also be used. This helps to reduce clutter when there are large amounts of activity and objects in a place. Two container objects can be merged, or one can be put in the other. A pinch to close, and un-pinch to open, gestures and other gestures can manipulate container objects.

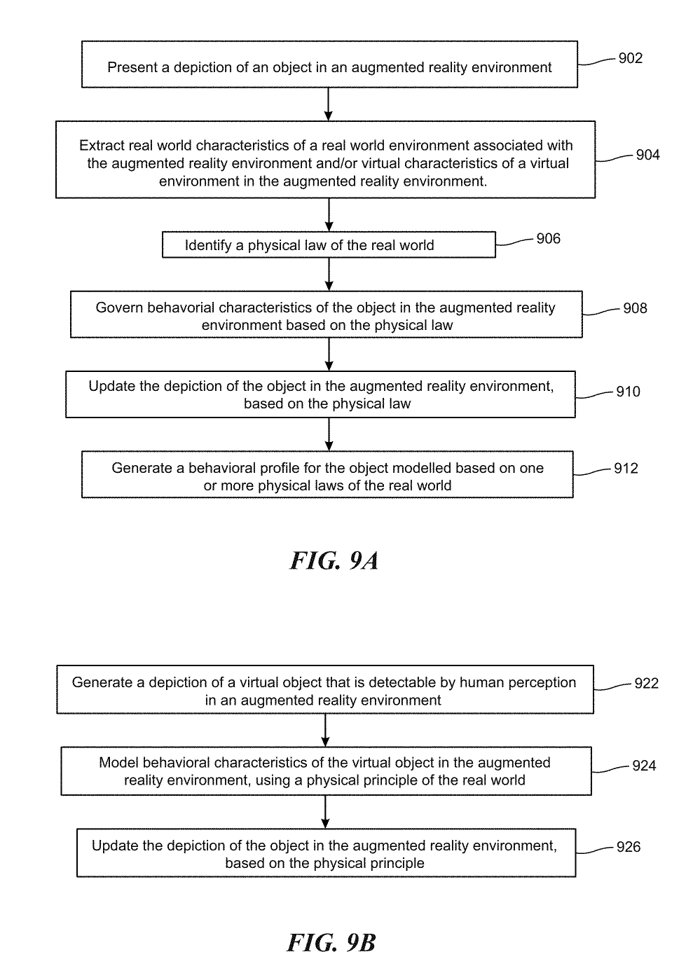

FIG. 9A-9B depict flow charts illustrating example processes to generate a behavioral profile for the object modelled based on a physical law of the real world and/or to update a depiction of the object in an augmented reality (AR) environment, based on a physical law or principle, in accordance with embodiments of the present disclosure.

In process 902, a depiction of an object is presented in an augmented reality environment. The depiction of the object is presented as being observable in the augmented reality environment. In general, the augmented reality environment includes a virtual environment where the virtual environment is observed by a human user to be overlaid or superimposed over a representation of the real world environment, in the augmented reality environment. The representation of the real world environment can, for instance, by any representation that is at last partially photorealistic to the real world environment and can be imaged, drawn, illustrated or digitally rendered or digitally synthesized, including by way of example, a camera view, a video view, a real time or near real time video, a recorded video, an image, a photograph, a drawing, a rendering, an animation, etc.

The object (or virtual object, VOB) can be presented or depicted as being in or associated with the virtual environment of the augmented reality environment. The object or virtual object is generally digitally rendered or synthesized by a machine (e.g., a machine can be one or more of, client device 102 of FIG. 1, client device 402 of FIG. 4A or server 100 of FIG. 1, server 300 of FIG. 3A) to be presented in the AR environment and have human perceptible properties to be human discernible or detectable.

The object or virtual object, in the augmented reality environment, is rendered or depicted to have certain animation, motion, movement, or other behavioral characteristics, either without stimulation (e.g., proactive behavior), or in reaction to, or in response to interaction, or an action (e.g., reactive behavior) by real world activity or virtual world. Note that behavioral characteristics include any attribute or character that is human perceivable or observable, including by way of example, visible characteristics (e.g., indicated by animation, color, associated text, movement, motion, lighting, anything affecting shape form or other visible appearance) of the virtual object.

VOB behavioral characteristics can also include, audible characteristics (e.g., music, sounds, speech, tone, steady state audio or audio upon impact, pitch, time shift in sound, etc.) of the virtual object. Furthermore, behavioral characteristics of VOBs can include tactile or haptic or olfactory characteristics that are rendered in the AR environment for discernibility by a human user.

In a further embodiment, behavioral characteristics can include properties or actions of a real world object which the object depicts or represents. A virtual object can have reactive or proactive behaviors so that it can respond to stimuli, and/or it can appear to move around in physical space around the human user and/or around the content or thing(s) the virtual object is relative to.

In general, the behavioral characteristics govern, one or more of, proactive behavior, reactive behavior, steady state action/vibration/lighting effect/audio effect of the object in the augmented reality environment

The objects can for example, in accordance with embodiments of the present disclosure, behave in a manner (e.g., have behavioral characteristics) that is similar to physical objects/things and that can be interacted with in a manner that is similar to interacting with physical objects.

In one example, virtual objects are virtual things that entities (e.g., human users) can act on or interact with, in a manner that is similar to how a human person can act on or interact with a real physical object in the real world. Virtual objects can obey certain virtual physics laws that govern how they move and/or behave in the virtual environment in which the VOBs are depicted or exist, and govern how they react or act as depicted in the AR environment, in response to human user action.

A VOB can also obey a physics model in a virtual world such that, via gestures or other physical actions by a human user (e.g., detected by imaging units, sensors or cameras on one or more mobile devices or sensors in the real world location the human user is in), the virtual object can be moved, grabbed, rotated, pushed, pulled, bounced, thrown, manipulated, etc. like a physical object. For example, a virtual object that simulates an elastic ball can be poked by a human user and in response the AR environment depicts animation of depression of the elastic ball and return to original form.

A virtual object which simulates an egg may break when dropped on the floor or when the human user exerts force on it which exceeds a certain threshold. A virtual object which simulates a football (soccer ball as illustrated in the example of FIG. 2A), can be kicked by a human user. When the simulated football is kicked by the human user, it can depict a movement or flight trajectory modeled based on physical properties of a real football, and/or micro deformities, if any, in the shape or form of the simulated football that is depicted. The AR environment can also render any audio data that simulates the sound of a football being kicked. The movement or flight trajectory can be based on physical parameters of the human user's kick (e.g., speed, how hard, how far, which angle, which direction, etc.). The simulated sound that is rendered can have a volume based on how hard the human user kicked or otherwise came in contact with the virtual or simulated football.

Note that any human perceptible characteristic (e.g., visual, sound, tactile, haptic, etc.) of the virtual object can be rendered or depicted based on physical principles.

A VOB can also behave as if it is interacting with other virtual objects in the AR environment, in a manner that corresponds to a physics model or physical principles of the real world. For example, if a virtual object that is a virtual baseball, is hit by another virtual object that is a bat, the virtual baseball can fly in a trajectory in the AR environment similar to how a real baseball bat hits a real baseball. Similarly, a virtual object can behave as if it is interacting with physical objects in the real world environment, in a manner that corresponds to a physics model or physical laws of the real world. In addition, a first virtual object can interact with another virtual object. This can be considered as a virtual unit in the AR environment. The virtual unit can be acted on or interacted with by a real entity or by another virtual object, with the expressed characteristics modeled by physical laws or principles.

The virtual unit can include any number of virtual objects. Physical laws or principles can be used to model the behavior characteristics of any virtual object or any virtual unit containing multiple virtual objects.

For example, if a simulated (e.g., virtual) block of ice is placed on a simulated glass of water (e.g., virtual water), the virtual ice block can be rendered as floating on the virtual water (e.g., based on liquid density, etc.). The virtual ice in the virtual glass of water can be considered as a ‘virtual unit’ in the AR environment. Multiple ice blocks in the virtual water glass (can be another virtual unit) can also make sounds rendered in the AR environment based on how fast the virtual water glass is being moved around (e.g., moved around by a human user of the AR environment or moved around by another virtual object (e.g., a simulated user (e.g., a VOB that is an actor not controlled by a human), or another virtual object (e.g., a virtual table that may be moving around causing the virtual water glass to move)).

In process 904, real world characteristics of a real world environment associated with the augmented reality environment can be extracted. The real world characteristic can include, natural phenomenon of the real world environment, and characteristics of the natural phenomenon. Natural phenomenon and its characteristics can include, wind and wind speed, rain and its heaviness, earthquake and its Richter scale, fire and its temperature, etc.

Real world characteristics can also include physical things of the real world environment, and an action, behavior or characteristics of the physical things. A physical thing and its action/behavior/characteristic can include, a tree and its height, a real dog and its height, weight or speed of movement, a physical bat and its color, weight, condition, whether it is hitting something, etc.

Real world characteristics can also a human user in the real world environment, and action or behavior of the human user. A human user in the real world environment and its action or behavior, can include. If the human user is holding something, hitting something, running, squeezing something, singing, yelling, speaking certain words, phrases or word sequences, certain gestures by the fingers, hands, limbs, torso, head, action of motion of the user's eyes, etc.

In addition, virtual characteristics of a virtual environment in the augmented reality environment can also be extracted or determined. The virtual world characteristics of the virtual environment, can include, virtual phenomenon of the virtual environment and characteristics of a natural phenomenon which the virtual phenomenon emulates. For example, virtual phenomenon can include, in the virtual environment of the AR environment, a simulated snow storm and its heaviness, a sandstorm and its windspeed, etc.

The virtual world characteristics of the virtual environment can also include, virtual things of the virtual world environment, and action, behavior or characteristics of the virtual things. A virtual thing and its action/behavior/characteristic can include, a building and its height, a virtual cat and its color, weight or speed of movement, a height it jumps, a virtual golf club and its weight, condition, whether it is in motion or hitting something, etc.

The virtual world characteristics of the virtual environment can also include, a virtual actor in the virtual world environment, and action or behavior of the virtual actor. The virtual actor in the VR environment of the AR environment and its action or behavior, can include, if the virtual actor is holding something, hitting something, running, squeezing something, singing, yelling, speaking certain words, phrases or word sequences, certain gestures by the fingers, hands, limbs, torso, head, action of motion of the actor's eyes, etc. If the virtual actor is shooting at something, driving a car, in the AR environment, etc.

In process 906, a physical law of the real world is identified based on the real world characteristics of the real world environment and/or the virtual characteristics of the virtual environment, or any combination of the above. Note in accordance with embodiments of the present disclosure, physical laws include by way of non-limiting example, one or more of, laws of nature, a law of gravity, a law of motion, electrical properties, magnetic properties, optical properties, Pascal's principle, laws of reflection or refraction, a law of thermodynamics, Archimedes' principle or a law of buoyancy, mechanical properties of materials; wherein, the mechanical properties of materials include, one or more of: elasticity, stiffness, yield, ultimate tensile strength, ductility, hardness, toughness, fatigue strength, endurance limit.

In process 908, behavioral characteristics of the object in the augmented reality environment are governed based on the physical law. In process 910, the depiction of the object in the augmented reality environment is updated based on the physical law. In process 912, a behavioral profile for the object modelled based on one or more physical laws of the real world. The behavioral profile can include the behavioral characteristics. In process 922, a depiction of a virtual object that is detectable by human perception in an augmented reality environment is generated, for observation by a human user.

In process 924, behavioral characteristics of the virtual object is modelled in the augmented reality environment, using a physical principle of the real world. In general, the physical principle can be identified based on one or more of: real world characteristics of a real world environment associated with the augmented reality environment and/or virtual characteristics of a virtual environment in the augmented reality environment. The depiction of the object that is updated in the augmented reality environment, can include one or more of, a visual update, an audible update, a sensory update, a haptic update, a tactile update and an olfactory update.

In one embodiment, the virtual object further comprises interior structure or interior content. The interior content can be consumable by a human user, on entering the virtual object. The internal structure can be perceivable by the human user, on entering the virtual object. For example, virtual object can represent a virtual place; wherein a human user of the augmented reality environment, is able to enter the virtual place represented by the virtual object, by stepping into it. On entering the virtual object, the virtual place within the virtual object world can be accessible by the human user (a user can see it as if looking from inside it). The virtual place type virtual objects, then enable a user to move around within a virtual world that is rendered as the interior of that object. For example, a VR/AR house could have internal rooms. An AR cave could have an AR treasure chest.

In process 926, the depiction of the object is updated in the augmented reality environment, based on the physical principle.

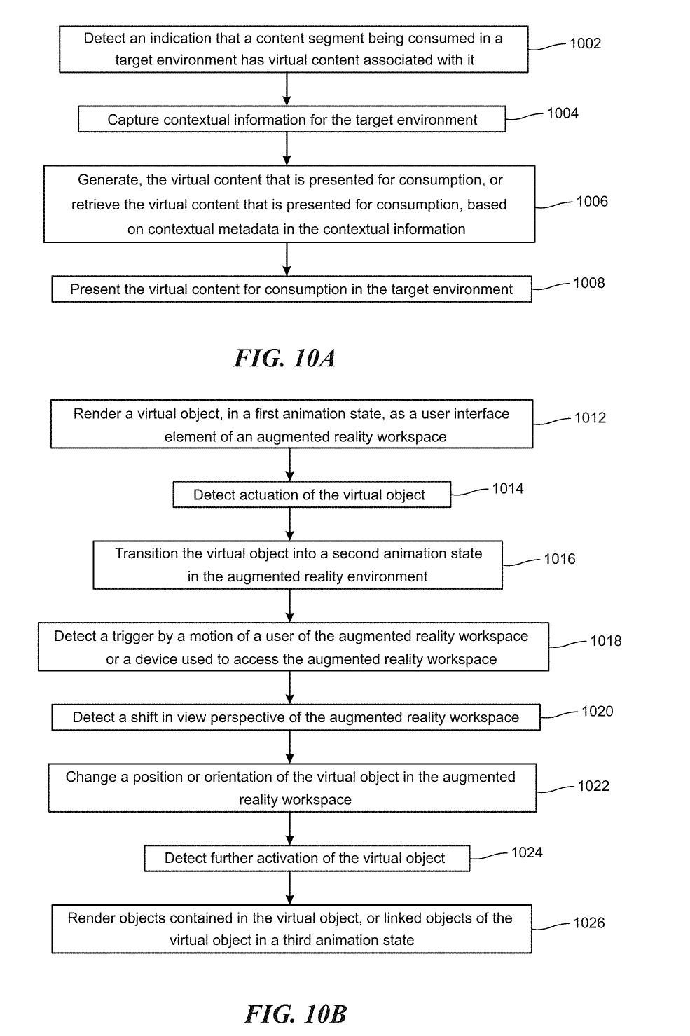

FIG. 10A depicts a flow chart illustrating an example process to present virtual content for consumption in a target environment, in accordance with embodiments of the present disclosure.

In process 1002, It is detected that an indication that a content segment being consumed in a target environment has virtual content associated with it. The content segment can include a segment of one or more of, content in a print magazine, a billboard, a print ad, a board game, a card game, printed text, any printed document. The content segment can also include a segment of one or more of, TV production, TV ad, radio broadcast, a film, a movie, a print image or photograph, a digital image, a video, digitally rendered text, a digital document, any digital production, a digital game, a webpage, any digital publication.

A user can be consuming content segment when the content segment is being interacted with (e.g. using a pointer, a cursor, a virtual pointer, virtual tool, via gesture, eye tracker, etc.), being played back, is visible, is audible or is otherwise human perceptible in the target environment.

A target environment can for example, include, a TV unit, an entertainment unit, a speaker, a smart speaker, any AI enabled speaker/microphone, a scanning/printing device, a radio, a physical room, a physical environment, a vehicle, a road, any physical location in any arbitrarily defined boundary, a portion of a room, a portion/floor(s) of a building, a browser, a desktop app, a mobile app, a mobile browser, a user interface on any digital device, a mobile display, a laptop display, a smart glass display, a smart watch display, a head mounted device display, any digital device display, physical air space associated with any physical entity (e.g., physical thing, person, place or landmark) etc.

The content segment can be certain frame(s) of a TV production, film or movie or live (near live) or recorded video, that is digital or analogue or any sequence of images, currently being played back in the target environment. The content segment can be certain section(s) of a radio broadcast, a sound track, an mp3, a podcast, an audio book, any audio track, or audio stream, a concert, a live concert, a recorded concert, etc. The content segment can be a portion or part of an image, photograph, animation, a sequence of digital images or digital photographs.

The content segment can also be any part of print (physical) content, such as a portion of magazine/book page, a given set of pages in a magazine/book, a portion of a print or certain pages of print ads (flyers, brochures), a card game (e.g., certain cards, or certain card sequences), any part of a printed text or any printed document, or a set of printed documents or any other print publications.

The content segment can be any part of a digital document, a subset of a set of digital documents (e.g., a word doc, text file, pdf, xml, etc.) that is open, on display or read, any portion(s) of a digital production (a mixture of text, videos, audio and/or images), a portion of a digital game, when certain levels in a game is reached, when certain ghosts appear or certain landmarks appear in a given digital game, a portion of a webpage, a set of pages associated with a given URL, etc.

When points or directs an augmented reality enabled device or directs its attention to, at any type of content or physical object, in accordance with embodiments of the present disclosure, software agents or software/hardware modules on their device can determine that there are or may be virtual objects associated with that content, through the detected indications.

Note that the indication that the content segment being consumed in the target environment has virtual content associated with it can include, one or more of: a pattern of data embedded in the content segment. The indication that the content segment being consumed in the target environment has virtual content associated with it can also include visual markers in the content segment, the visual markers being perceptible or imperceptible to a human user (e.g., visible or invisible markers embedded in the content that indicate that virtual objects are associated with that content).

In addition, the indication that the content segment being consumed in the target environment has virtual content associated with it can also include sound markers or a pattern of sound embedded in the content segment, the sound markers being perceptible or imperceptible to a human user (audible or non-audible sounds or sound patterns embedded in the content that indicate that virtual objects are associated with that content).

The indication can in some instances be delivered or detected by the user device via, one or more of, cellular, Wi-Fi, visual light, IR signals, acoustic signals, beacons, magnetic field lines, electromagnetic fields, laser data transfer.

In a further embodiment, the indication is determined through analysis of content type of the content segment being consumed. By analyzing the content, for example, the type of content (format, genre) the channel that the content is conveyed through (a TV or radio or online channel, a particular publication, a specific website, a music station or channel, a news channel, etc.), the date and time, and/or the location of the target environment and/or data regarding the user consuming the content in the target environment.

In process 1004, contextual information of the target environment is captured. The wealth of contextual information about the target environment that is extractable in accordance with the disclosed technology, enables VOBs to be delivered intelligently and/or in a context aware or relevant manner, to the target environment. The contextual information can be used to identify, detect, VOBs or create, generate the context relevant/aware VOBs in real time or near real time, based on the real time contextual information that is captured.

The contextual information can include, one or more of: an identifier of a device used to consume the content segment in the target environment, timing data associated with consumption of the content segment in the target environment, software on the device, cookies on the device; indications of other virtual objects on the device.

Contextual information can include, one or more of: identifier of a human user in the target environment; timing data associated with consumption of the content segment in the target environment; interest profile of the human user; behavior patterns of the human user; pattern of consumption of the content segment; attributes of the content segment. Additionally, contextual information can also include, one or more of: pattern of consumption of the content segment; attributes of the content segment; location data associated with the target environment; timing data associated with the consumption of the content segment.

In process 1006, the virtual content that is presented for consumption is generated or retrieved, based on contextual metadata in the contextual information. In one embodiment, the virtual content that is associated with the content segment and presented in the target environment is generated on demand. In a further embodiment, the virtual content is retrieved at least in part from a remote repository in response to querying the remote repository using the contextual metadata. The virtual content is presented for consumption in target environment. The virtual content is contextually relevant to the target environment.

When an indication is found that there are virtual objects are associated with content or products that the user's device is sensing, any relevant or assigned associated virtual objects can be retrieved or generated (e.g., tailored to the scenario). For example, embodiments of the present disclosure can detect the indication that there are or may be virtual objects for the content or products that are sensed, and can query a database or another application to get the associated virtual objects. The query can include a search or it can include a request or set of requests for specific virtual objects.

Further embodiments of the present disclosure (e.g., software agents and/or hardware modules, e.g., client device 402 of FIG. 4A) can receive associated virtual objects by pulling them from a server, or by having them pushed to it, via appropriate delivery channels.

Further embodiments of the present disclosure (e.g., software agents and/or hardware modules, e.g., client device 402 of FIG. 4A) can generate new or unique virtual objects for the associated content locally as well. The retrieved or generated virtual objects can be specifically or dynamically associated with any content, users, dates, times, places and contexts. Virtual objects can also be generated dynamically on-demand, or they can be pulled or pushed from a database of existing defined virtual objects.

In general, virtual objects can be specifically or dynamically associated with a segment of content for one or many users, at any set of places and times and contexts, user requests or wants, user interest profiles, user behavior patterns, or patterns of data about the usage of the content, the user location, ratings or audience metrics for the content, advertising budgets for virtual objects and advertising budgets for the content.

Virtual objects can be targeted and/or personalized to environments, users and/or audiences by geography, demographics, psychographics, context, software on the device, the device ID, type of device, the user ID, intent, cookies or other analytics and data about the users and/or audiences, or the state of other software on the user device or that is associated with a user ID, or the set of other virtual objects that a user already has seen or has created or has collected or interacted with, or the user's social network graph or interest graph.

When virtual objects are associated with content or physical objects that a user device is sensing, they can then be rendered for the user, and the user can interact with those objects via their device. For example, while watching a TV show, when an advertisement appears, the user's device can detect that there are virtual objects associated with that ad. The virtual objects can be retrieved or generated for the user. These objects then appear in augmented reality or virtual reality on the user's device and the user can interact with them.

For example, during a TV or radio commercial for a sneaker brand, the user's device (e.g., client device 402 of FIG. 4A) can detect that there are virtual objects associated with the commercial and can notify the user that there are objects, and/or can render those objects for the user such that they can see, hear, touch, play with, collect, share, copy, comment on, like, follow, or perform or initiate other interactions with, the objects.

For example, while watching a TV show or TV ad, if the user looks at the TV via an imaging unit of a user device (e.g., client device 402 of FIG. 4A e.g., a phone's video camera), they could see a virtual object for product placement or game object or an avatar or coupon or other virtual goods item, appear as if floating in front of their TV in the room, or appearing and doing something (such as moving around or animating in some way) somewhere in the room around them and the TV. They can then interact with that virtual object in various ways (rotate it, zoom in/out, explore its features, collect it into their inventory of virtual objects, touch it, get a coupon from it, receive rewards points for interacting with it, get a gift from it, win something by interacting with, get a sweepstakes ticket from it, share it with friends, add it to their avatar, buy the virtual object, buy the actual sneaker product that it is associated with, get data or information from it, comment on it, like it, rate it, etc.).

Similarly, when looking at any page of a magazine, or at any billboard or print ad, or any web page on their computer, software on a user's device can detect and render virtual objects associated with that content and the user can then interact with those objects. In a further example, when a user views a specific physical object via their device video camera (e.g., via client device 402 of FIG. 4A), associated virtual objects for that physical object can be detected, and rendered and interacted with. When a user performs any of the above through a still image camera or a still image, by listening through the microphone on their device, or by sensing their location via GPS or any other form of geo-positioning, with or without looking through the video camera on a device (e.g., client device 402 of FIG. 4A). The example steps as described above can also apply in order to detect and render virtual objects that the user can then interact with.

The applications of the above methods of detecting and rendering associated virtual objects for content and physical objects, that users can interact with, can be applied to any form of content and advertising (TV, radio, print, physical billboards, online, mobile, film and video, etc.) as well as to all kinds of physical objects or commercial products that can be recognized by a user device (e.g., client device 402 of FIG. 4A) (soda cans, product packaging, car brands, anything with a recognizable name or logo on it, consumer electronics products, cosmetics products, home appliances, etc.).

FIG. 10B depicts a flow chart illustrating an example process to provide an augmented reality workspace (AR workspace) in a physical space, in accordance with embodiments of the present disclosure.

In process 1012, a virtual object is rendered in a first animation state, as a user interface element of an augmented reality workspace. The user interface element represented by the virtual object can include one or more of, a folder, a file, a data record, a document, linked documents, an application, a system file, a trash can, a pointer, a menu, a task bar, a launch pad, a dock, a lasso tool. The user interface elements and interactions are disclosed for enabling users of an augmented reality or virtual reality application to interact with virtual objects.

For example, a dock or launchpad object can appear in physical space around the user as a part of the AR workspace or any other AR environment. By activating this object it opens or expands out a set of menu actions, task lists, task bars and/or associated virtual objects. The virtual trash can include garbage disposal or black hole for putting virtual objects or content into that the user wants to dispose of. A virtual object can launch an application or document within the AR workspace, a virtual workspace, or any other AR, MR or VR environment. In a further embodiment, a virtual object can function as an alias or pointer or hyperlink to another virtual object.

The virtual object can be rendered in a first animation state, in accordance with state information associated with the virtual object. In general, the user interface element of the augmented reality workspace is rendered as being present in the physical space and able to be interacted with in the physical space. In general, the augmented reality workspace can be depicted in an augmented reality interface via one or more of, a mobile phone, a glasses, a smart lens and a headset device; wherein, augmented reality workspace is depicted in 3D in the physical space and the virtual object is viewable in substantially 360 degrees.

In process 1014, actuation of the virtual object is detected. The actuation can be detected from one or more of, an image based sensor, a haptic or tactile sensor, a sound sensor or a depth sensor. The actuation can also be detected from input submitted via, one or more of, a virtual laser pointer, a virtual pointer, a lasso tool, a gesture sequence of a human user in the physical space.

For example, users can hover a reticle/pointer or click or gesture or speak a command to activate and/or open an object. A ‘reticle’ appears on the user's screen and/or at a variable or fixed distance and point in space in front of them. Note that reticle can refer to a pointer or selector for augmented reality, virtual reality and/or mixed reality applications. In some embodiments, the reticle can be moved in or via the physical space around the user by gesture detection e.g., head, arms, legs, torso, limbs, hands, etc.), eye tracking or other ways of control by a virtual controller.

One embodiment includes a virtual laser pointer that appears in the AR workspace or any other AR or VR environment. The virtual laser pointer can be used to select virtual objects or other entities (e.g., other users, other actors) to interact with via the user's device. The virtual laser pointer can be aimed by the user's device and/or instructed via a gesture in front of or behind a device, or any sensing unit.

Embodiments of the present disclosure include, a virtual lasso gesture that enables the user to select a set of adjacent virtual objects or virtual objects in a region of a user interface. The virtual lasso gesture or tool can then enable the user to operate on them as grouped objects. A virtual lasso gesture, can include, for example using a virtual lasso tool, the reticle or pointer to draw a selection path around the objects, or it can be using a net to capture the objects or a sequence of gestures.

Note that sequences of gestures can trigger or cause actions in the virtual objects. The same gestures in different sequences can have different effects. Gestures and gesture sequences form a grammar and syntax for composing gestural expressions that have specific effects on objects or object behavior, or user experience in the AR workspace or any AR/VR environment.

In one example, by making an “ok” gesture (or other finger/thumb arrangements or shape) with thumb and forefinger and putting the gesture around an object (VOB) in a field of view (e.g., a user's field of view via a device such as a front facing camera), an object can be circled in the fingers. Sensors of the AR workspace or AR environment can detect the gesture and determine which object is circled and which in turn can cause the reticle to select that object. In one embodiment, another finger gesture or shape can be used such as a pinch or simply pointing at a VOB.

When the screen or device is directed to or pointed at an object, the reticle can select the nearest object. The reticle can be moved around to vary which object is selected. If they hover on a selected object it then appears to change state to indicate that it is activated. If the user then hovers the reticle on an activated state object it triggers the next state of the object, which can open the object or launch the object's menu of actions, or to initiate an interaction with the object.

Note that an object can have a series of multiple states that are triggered by hovering on it during each successive state. In process 1016, the virtual object is transitioned into a second animation state in the augmented reality environment.

The virtual object can contain internally additional objects or be actuated to access linked objects. One embodiment includes, rendering objects contained in the virtual object, or linked objects of the virtual object in the second animation state. For example, a series of container objects or linked objects can be opened by hovering on an object causing a next set of objects to appear, and then selecting and hovering on a next object to continue navigating through a tree or directory or web of objects

Virtual objects that act as containers for other virtual objects. The other virtual objects can be container objects or non-container objects. A container object is like a folder or box for other objects. When this type of object is opened its contents can appear in space as a set of virtual objects.

In process 1018, a trigger by a motion of a user of the augmented reality workspace or a device used to access the augmented reality workspace is detected. In process 1020, a shift in view perspective of the augmented reality workspace is detected. Note that the shift in the view perspective can also be triggered by a motion of, one or more of: detecting a speed or acceleration of the motion. The acceleration or speed of the change of the position or orientation of the virtual object can depend on a speed or acceleration of the motion of the user or the device.

In one example, by accelerating the movement of the device or screen the user can accelerate the movement and change in location of the reticle in the AR environment or virtual workspace, like one accelerates the movement of the mouse pointer on a computer screen. This enables a smaller and/or faster gesture to cause a larger effect on the reticle's location.

In process 1022, a position or orientation of the virtual object is changed in the augmented reality workspace, for example, in response to the shift in view perspective of the AR workspace. In process 1024, further activation of the virtual object is detected. In process 1026, objects contained in the virtual object, or linked objects of the virtual object are rendered in a third animation state. Additional or less animation states can be enabled for any virtual object, and actuated in response to user action or without human trigger.

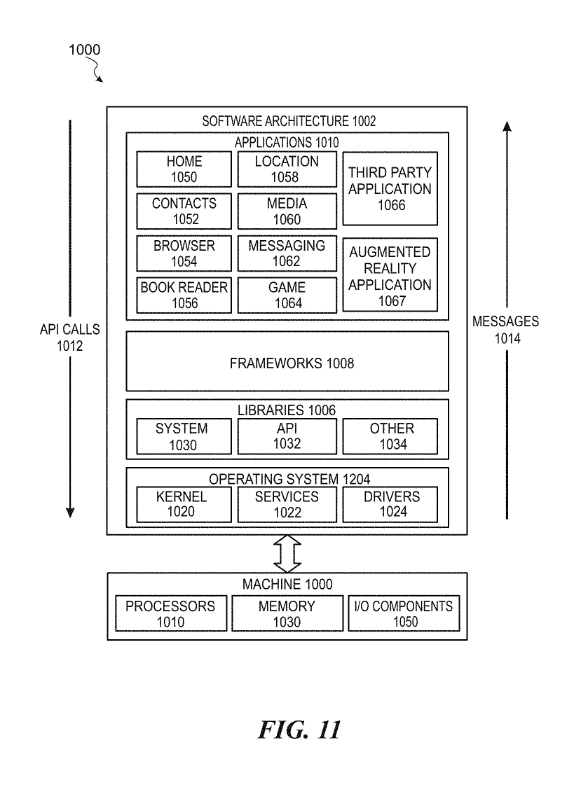

FIG. 11 is a block diagram illustrating an example of a software architecture 1100 that may be installed on a machine, in accordance with embodiments of the present disclosure.

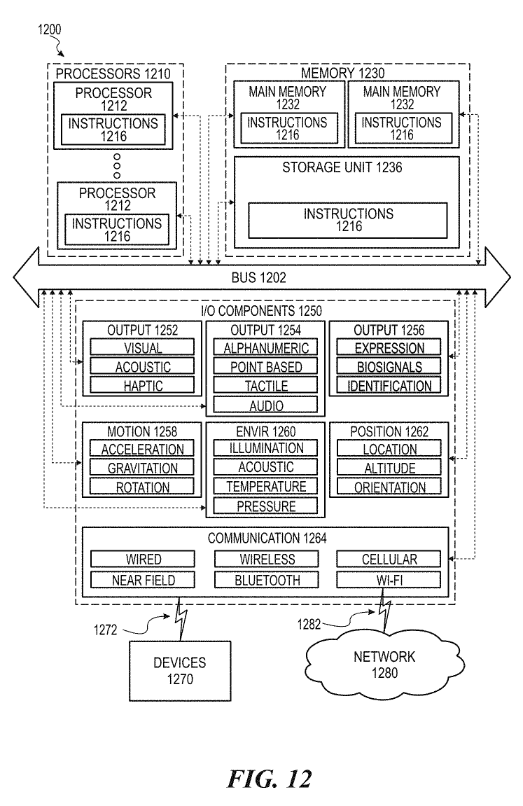

FIG. 11 is a block diagram 1100 illustrating an architecture of software 9902, which can be installed on any one or more of the devices described above. FIG. 1100 is a non-limiting example of a software architecture, and it will be appreciated that many other architectures can be implemented to facilitate the functionality described herein. In various embodiments, the software 1102 is implemented by hardware such as machine 1200 of FIG. 12 that includes processors 1210, memory 1230, and input/output (I/O) components 1250. In this example architecture, the software 1102 can be conceptualized as a stack of layers where each layer may provide a particular functionality. For example, the software 902 includes layers such as an operating system 1104, libraries 1106, frameworks 1108, and applications 1110. Operationally, the applications 1110 invoke API calls 1112 through the software stack and receive messages 1114 in response to the API calls 1112, in accordance with some embodiments.

In some embodiments, the operating system 1104 manages hardware resources and provides common services. The operating system 1104 includes, for example, a kernel 1120, services 1122, and drivers 1124. The kernel 1120 acts as an abstraction layer between the hardware and the other software layers consistent with some embodiments. For example, the kernel 1120 provides memory management, processor management (e.g., scheduling), component management, networking, and security settings, among other functionality. The services 1122 can provide other common services for the other software layers. The drivers 1124 are responsible for controlling or interfacing with the underlying hardware, according to some embodiments. For instance, the drivers 1124 can include display drivers, camera drivers, BLUETOOTH drivers, flash memory drivers, serial communication drivers (e.g., Universal Serial Bus (USB) drivers), WI-FI drivers, audio drivers, power management drivers, and so forth.

In some embodiments, the libraries 1106 provide a low-level common infrastructure utilized by the applications 1110. The libraries 1106 can include system libraries 930 (e.g., C standard library) that can provide functions such as memory allocation functions, string manipulation functions, mathematics functions, and the like. In addition, the libraries 1106 can include API libraries 1132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1106 can also include a wide variety of other libraries 1134 to provide many other APIs to the applications 1110.

The frameworks 1108 provide a high-level common infrastructure that can be utilized by the applications 1110, according to some embodiments. For example, the frameworks 1108 provide various graphic user interface (GUI) functions, high-level resource management, high-level location services, and so forth. The frameworks 1108 can provide a broad spectrum of other APIs that can be utilized by the applications 1110, some of which may be specific to a particular operating system 1104 or platform.

In an example embodiment, the applications 1110 include a home application 1150, a contacts application 1152, a browser application 1154, a search/discovery application 1156, a location application 1158, a media application 1160, a messaging application 1162, a game application 1164, and other applications such as a third party application 1166. According to some embodiments, the applications 1110 are programs that execute functions defined in the programs. Various programming languages can be employed to create one or more of the applications 1110, structured in a variety of manners, such as object-oriented programming languages (e.g., Objective-C, Java, or C++) or procedural programming languages (e.g., C or assembly language). In a specific example, the third party application 1166 (e.g., an application developed using the Android, Windows or iOS. software development kit (SDK) by an entity other than the vendor of the particular platform) may be mobile software running on a mobile operating system such as Android, Windows or iOS, or another mobile operating systems. In this example, the third party application 1166 can invoke the API calls 1112 provided by the operating system 1104 to facilitate functionality described herein.

An augmented reality application 1167 may implement any system or method described herein, including integration of augmented, alternate, virtual and/or mixed realities for digital experience enhancement, or any other operation described herein.

FIG. 12 is a block diagram illustrating components of a machine 1200, according to some example embodiments, able to read a set of instructions from a machine-readable medium (e.g., a machine-readable storage medium) and perform any one or more of the methodologies discussed herein.

Specifically, FIG. 12 shows a diagrammatic representation of the machine 1200 in the example form of a computer system, within which instructions 1216 (e.g., software, a program, an application, an applet, an app, or other executable code) for causing the machine 1200 to perform any one or more of the methodologies discussed herein can be executed. Additionally, or alternatively, the instruction can implement any module of FIG. 3A and any module of FIG. 4A, and so forth. The instructions transform the general, non-programmed machine into a particular machine programmed to carry out the described and illustrated functions in the manner described.

In alternative embodiments, the machine 1200 operates as a standalone device or can be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 can comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a head mounted device, a smart lens, goggles, smart glasses, a smart home device (e.g., a smart appliance), other smart devices, a web appliance, a network router, a network switch, a network bridge, a Blackberry, a processor, a telephone, a web appliance, a console, a hand-held console, a (hand-held) gaming device, a music player, any portable, mobile, hand-held device or any device or machine capable of executing the instructions 1016, sequentially or otherwise, that specify actions to be taken by the machine 1200. Further, while only a single machine 1200 is illustrated, the term “machine” shall also be taken to include a collection of machines 1000 that individually or jointly execute the instructions 1216 to perform any one or more of the methodologies discussed herein.

The machine 1200 can include processors 1210, memory/storage 1230, and I/O components 1250, which can be configured to communicate with each other such as via a bus 1202. In an example embodiment, the processors 1210 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) can include, for example, processor 1012 and processor 1014 that may execute instructions 1016. The term “processor” is intended to include multi-core processor that may comprise two or more independent processors (sometimes referred to as “cores”) that can execute instructions contemporaneously. Although FIG. 12 shows multiple processors, the machine 1200 may include a single processor with a single core, a single processor with multiple cores (e.g., a multi-core processor), multiple processors with a single core, multiple processors with multiples cores, or any combination thereof.

The memory/storage 1230 can include a main memory 1232, a static memory 1234, or other memory storage, and a storage unit 1236, both accessible to the processors 1210 such as via the bus 1202. The storage unit 1236 and memory 1232 store the instructions 1216 embodying any one or more of the methodologies or functions described herein. The instructions 1216 can also reside, completely or partially, within the memory 1232, within the storage unit 1236, within at least one of the processors 1210 (e.g., within the processor's cache memory), or any suitable combination thereof, during execution thereof by the machine 1200. Accordingly, the memory 1232, the storage unit 1236, and the memory of the processors 1210 are examples of machine-readable media.

As used herein, the term “machine-readable medium” or “machine-readable storage medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” or “machine-readable storage medium” should be taken to include a single medium or multiple media (e.g., a centralized or distributed database, or associated caches and servers) able to store instructions 1216. The term “machine-readable medium” or “machine-readable storage medium” shall also be taken to include any medium, or combination of multiple media, that is capable of storing, encoding or carrying a set of instructions (e.g., instructions 1216) for execution by a machine (e.g., machine 1200), such that the instructions, when executed by one or more processors of the machine 1200 (e.g., processors 1210), cause the machine 1200 to perform any one or more of the methodologies described herein. Accordingly, a “machine-readable medium” or “machine-readable storage medium” refers to a single storage apparatus or device, as well as “cloud-based” storage systems or storage networks that include multiple storage apparatus or devices. The term “machine-readable medium” or “machine-readable storage medium” excludes signals per se.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The I/O components 1250 can include a wide variety of components to receive input, provide output, produce output, transmit information, exchange information, capture measurements, and so on. The specific I/O components 1250 that are included in a particular machine will depend on the type of machine. For example, portable machines such as mobile phones will likely include a touch input device or other such input mechanisms, while a headless server machine will likely not include such a touch input device. It will be appreciated that the I/O components 1250 can include many other components that are not shown in FIG. 12. The I/O components 1250 are grouped according to functionality merely for simplifying the following discussion and the grouping is in no way limiting. In example embodiments, the I/O components 1250 can include output components 1252 and input components 1254. The output components 1252 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1254 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), eye trackers, and the like.

In further example embodiments, the I/O components 1252 can include biometric components 1056, motion components 1258, environmental components 1260, or position components 1262 among a wide array of other components. For example, the biometric components 1256 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1258 can include acceleration sensor components (e.g., an accelerometer), gravitation sensor components, rotation sensor components (e.g., a gyroscope), and so forth. The environmental components 1260 can include, for example, illumination sensor components (e.g., a photometer), temperature sensor components (e.g., one or more thermometers that detect ambient temperature), humidity sensor components, pressure sensor components (e.g., a barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 1262 can include location sensor components (e.g., a GPS receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 1250 may include communication components 1264 operable to couple the machine 1200 to a network 1280 or devices 1270 via a coupling 1282 and a coupling 1272, respectively. For example, the communication components 1264 include a network interface component or other suitable device to interface with the network 1280. In further examples, communication components 1264 include wired communication components, wireless communication components, cellular communication components, Near Field Communication (NFC) components, Bluetooth. components (e.g., Bluetooth. Low Energy), WI-FI components, and other communication components to provide communication via other modalities. The devices 1270 may be another machine or any of a wide variety of peripheral devices (e.g., a peripheral device coupled via a USB).

The network interface component can include one or more of a network adapter card, a wireless network interface card, a router, an access point, a wireless router, a switch, a multilayer switch, a protocol converter, a gateway, a bridge, bridge router, a hub, a digital media receiver, and/or a repeater.

The network interface component can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

Moreover, the communication components 1264 can detect identifiers or include components operable to detect identifiers. For example, the communication components 1264 can include Radio Frequency Identification (RFID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 1264, such as location via Internet Protocol (IP) geo-location, location via WI-FI signal triangulation, location via detecting a BLUETOOTH or NFC beacon signal that may indicate a particular location, and so forth.

In various example embodiments, one or more portions of the network 1080 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a WI-FI® network, another type of network, or a combination of two or more such networks. For example, the network 1280 or a portion of the network 1280 may include a wireless or cellular network, and the coupling 1282 may be a Code Division Multiple Access (CDMA) connection, a Global System for Mobile communications (GSM) connection, or other type of cellular or wireless coupling. In this example, the coupling 1282 can implement any of a variety of types of data transfer technology, such as Single Carrier Radio Transmission Technology, Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, 5G, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1216 can be transmitted or received over the network 1280 using a transmission medium via a network interface device (e.g., a network interface component included in the communication components 1264) and utilizing any one of a number of transfer protocols (e.g., HTTP). Similarly, the instructions 1216 can be transmitted or received using a transmission medium via the coupling 1272 (e.g., a peer-to-peer coupling) to devices 1270. The term “transmission medium” shall be taken to include any intangible medium that is capable of storing, encoding, or carrying the instructions 1216 for execution by the machine 1200, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the innovative subject matter has been described with reference to specific example embodiments, various modifications and changes may be made to these embodiments without departing from the broader scope of embodiments of the present disclosure. Such embodiments of the novel subject matter may be referred to herein, individually or collectively, by the term “innovation” merely for convenience and without intending to voluntarily limit the scope of this application to any single disclosure or novel or innovative concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, 6, other aspects may likewise be embodied as a means-plus-function claim, or in other forms, such as being embodied in a computer-readable medium. (Any claims intended to be treated under 35 U.S.C. § 112, 6 will begin with the words “means for”.) Accordingly, the applicant reserves the right to add additional claims after filing the application to pursue such additional claim forms for other aspects of the disclosure.

1. A method of an augmented reality environment, the method, comprising:
presenting a depiction of an object in the augmented reality environment, the depiction of the object being observable in the augmented reality environment;
identifying a physical law of the real world, in accordance with which, behavioral characteristics of the object in the augmented reality environment are to be governed;
wherein, the physical law is identified based on one or more of:
real world characteristics of a real world environment associated with the augmented reality environment;
virtual characteristics of a virtual environment in the augmented reality environment.

2. The method of claim 1,
wherein the object is presented in the virtual environment;
further wherein, the virtual environment is observed by a human user to be overlaid or superimposed over a representation of the real world environment, in the augmented reality environment.

3. The method of claim 1, further comprising:
updating the depiction of the object in the augmented reality environment, based on the physical law;
wherein, the depiction of the object that is updated in the augmented reality environment includes one or more of, a visual update, an audible update, a sensory update, a haptic update, a tactile update and an olfactory update.

4. The method of claim 1,
wherein the real world characteristics include one or more of,
(i) natural phenomenon of the real world environment, and characteristics of the natural phenomenon;
(ii) physical things of the real world environment, and an action, behavior or characteristics of the physical things;
(iii) a human user in the real world environment, and action or behavior of the human user.

5. The method of claim 1,
wherein the virtual world characteristics of the virtual environment, include one or more of,
(i) virtual phenomenon of the virtual environment;
(ii) characteristics of a natural phenomenon which the virtual phenomenon emulates;
(iii) virtual things of the virtual world environment, and action, behavior or characteristics of the virtual things;
(iv) a virtual actor in the virtual world environment, and action or behavior of the virtual actor.

6. The method of claim 1, wherein, the behavioral characteristics includes properties or actions of a real world object which the object depicts or represents: further wherein, the behavioral characteristics govern, one or more of, proactive behavior, reactive behavior, steady state action of the object in the augmented reality environment.

7. (canceled)

8. The method of claim 1, further comprising, generating a behavioral profile for the object modeled based on one or more physical laws of the real world, wherein, the behavioral profile includes the behavioral characteristics.

9. The method of claim 8, wherein, the physical laws include, one or more of, laws of nature, a law of gravity, a law of motion, electrical properties, magnetic properties, optical properties, Pascal's principle, laws of reflection or refraction, a law of thermodynamics, Archimedes' principle or a law of buoyancy, mechanical properties of materials; wherein, the mechanical properties of materials include, one or more of: elasticity, stiffness, yield, ultimate tensile strength, ductility, hardness, toughness, fatigue strength, endurance limit.

10. A system, comprising:
means for, generating a depiction of a virtual object in an augmented reality environment, the depiction of the object being detectable by human perception in the augmented reality environment;
means for, using a physical principle of the real world to model behavioral characteristics of the virtual object in the augmented reality environment;
means for, updating the depiction of the object in the augmented reality environment, based on the physical principle.

11. The system of claim 10:
wherein, the physical principle is identified based on one or more of:
real world characteristics of a real world environment associated with the augmented reality environment;
virtual characteristics of a virtual environment in the augmented reality environment;
wherein, the depiction of the object that is updated in the augmented reality environment, includes one or more of, a visual update, an audible update, a sensory update, a haptic update, a tactile update and an olfactory update.

12. The system of claim 10,
wherein, the behavioral characteristics includes properties or actions of a real world object which the virtual object depicts or represents.

13. The system of claim 12,
wherein, virtual object represents a virtual place;
wherein a human user of the augmented reality environment, is able to enter the virtual place represented by the virtual object;
wherein, entering the virtual object, the virtual place within the virtual object world is accessible by the human user.

14. The system of claim 13,
wherein, virtual object further comprises interior structure or interior content;
wherein, the interior content is consumable by a human user, on entering the virtual object;
wherein, the internal structure is perceivable by the human user, on entering the virtual object.

15.-25. (canceled)

26. A machine-readable storage medium, having stored thereon instructions, which when executed by a processor, cause the processor to implement a method to provide an augmented reality workspace in a physical space, the method, comprising:
rendering a virtual object as a user interface element of the augmented reality workspace;
wherein, the virtual object is rendered in a first animation state, in accordance with state information associated with the virtual object;
wherein, the user interface element of the augmented reality workspace is rendered as being present in the physical space and able to be interacted with in the physical space;
responsive to actuation of the virtual object, transitioning the virtual object into a second animation state in the augmented reality environment in accordance with the state information associated with the virtual object;
further change a position or orientation of the virtual object in the augmented reality workspace, responsive to a shift in view perspective of the augmented reality workspace.

27. The method of claim 26, further comprising,
rendering objects contained in the virtual object, or linked objects of the virtual object in the second animation state; or
rendering objects contained in the virtual object, or linked objects of the virtual object in a third animation state responsive to further activation of the virtual object, in accordance with the state information.

28. The method of claim 26, wherein, the shift in the view perspective is triggered by a motion of, one or more of:
a user of the augmented reality work space;
a device used to access the augmented reality workspace;
further comprising, detecting a speed or acceleration of the motion;
wherein, acceleration or speed of the change of the position or orientation of the virtual object depends on a speed or acceleration of the motion of the user or the device.

29. The method of claim 26, wherein, the actuation is detected from one or more of, an image based sensor, a haptic or tactile sensor, a sound sensor or a depth sensor.

30. The method of claim 26, wherein, the user interface element represented by the virtual object includes one or more of, a folder, a file, a data record, a document, an application, a system file, a trash can, a pointer, a menu, a task bar, a launch pad, a dock, a lasso tool.

31. The method of claim 26, wherein the actuation is detected from input submitted via, one or more of, a virtual laser pointer, a virtual pointer, a lasso tool, a gesture sequence of a human user in the physical space,

32. The method of claim 26, wherein, the augmented reality workspace is depicted in an augmented reality interface via one or more of, a mobile phone, a glasses, a smart lens and a headset device; wherein, augmented reality workspace is depicted in 3D in the physical space and the virtual object is viewable in substantially 360 degrees.
